(19) United States
(12) Patent Application Publication
(10) Pub. No.: US 2020/0016739 A1
(43) Pub. Date: Jan. 16, 2020

(54) PERSONAL ROBOTIC SYSTEM AND METHOD

(71) Applicant: Willow Garage, Inc., Menlo Park, CA (US)

(72) Inventor: Melonee Wise, Santa Clara, CA (US)

(73) Assignee: Willow Garage, Inc., Menlo Park, CA (US)

(21) Appl. No.: 16/570,740

(22) Filed: Sep. 13, 2019

Related U.S. Application Data
(63) Continuation of application No. 16/283,588, filed on Feb. 22, 2019, now abandoned.
Application No. 16/283,588 is a continuation of application No. 15/083,065, filed on Mar. 28, 2016, now abandoned.
Application No. 15/083,065 is a continuation of application No. 14/826,415, filed on Aug. 14, 2015, now abandoned.
Application No. 14/826,415 is a continuation-in-part of application No. 14/584,158, filed on Dec. 29, 2014, now abandoned.
(60) Provisional application No. 61/921,673, filed on Dec. 30, 2013.

(51) Int. Cl. B25J 5/00; B25J 9/00

(52) U.S. Cl. CPC B25J 5/007; B25J 9/0003; Y10S 901/46; Y10S 901/47; Y10S 901/01

(57) ABSTRACT

One embodiment is directed to a personal robotic system, comprising: an electromechanical mobile base configured to be controllably movable upon a substantially planar surface in a global coordinate system wherein a Z axis is defined perpendicular to the substantially planar surface; a torso assembly movably coupled to the mobile base such that the torso may be controllably moved in a direction substantially parallel to the Z axis and also controllably rotated about an axis substantially perpendicular to the Z axis; a head assembly movably coupled to the torso assembly; a robotic arm operatively coupled to the torso assembly; and a controller operatively coupled to the mobile base, torso assembly, head assembly, and robotic arm, and configured to controllably manipulate nearby objects while also automatically minimizing destabilizing moments applied to the mobile base through movement of at least one of the mobile base, torso assembly, head assembly, and robotic arm.

### RELATED APPLICATION DATA

The present application is a continuation of U.S. patent application Ser. No. 16/283,588, filed on Feb. 22, 2019, which is a continuation of U.S. patent application Ser. No. 15/083,065, filed on Mar. 28, 2016 now abandoned, which is a continuation of U.S. patent application Ser. No. 14/826,415, filed on Aug. 14, 2015 now abandoned, which is a continuation of U.S. patent application Ser. No. 14/584,158, filed on Dec. 29, 2014 now abandoned, which claims the benefit under 35 U.S.C. § 119 to U.S. Provisional Applications Ser. No. 61/921,673 filed Dec. 30, 2013. The foregoing applications are hereby incorporated by reference into the present application in their entirety.

### FIELD OF THE INVENTION

The present invention relates generally to robotic systems for use in human environments, and more particularly to automated and semiautomated systems for assisting in the manipulation of human scale objects using an electromechanically movable base.

### BACKGROUND

Personal robots, such as those available under the tradenames Roomba® and PR2® by suppliers such as iRobot® and Willow Garage®, respectively, have been utilized in human environments to assist with human-scale task such as vacuuming and grasping various items, but neither of these personal robotic systems, nor others that are available, are well suited for operating in human environments such as elderly care facilities, hotels, or hospitals in a manner wherein they may be utilized to manipulate human-scale objects around using an efficient footprint with enhanced stability and range of motion and manipulation reach. In particular, there is a need for reliable and controllable systems that are capable of autonomous, semi-autonomous, and/or teleoperational activity in such environments wherein an objective is the movement of other human scale objects, such as almost any object or objects of reasonable mass and/or size that may be manipulated and carried manually by a human while also maintaining a highly geometrically efficient footprint, broad range of motion and operation, as well as overall dynamic stability. The embodiments described herein are intended to meet these and other objectives.

### BRIEF DESCRIPTION OF THE DRAWINGS

FIGS. 1A-1G illustrate conventional robotic systems that may be utilized in human environments for various tasks.

FIGS. 2A-2E illustrate various aspects of a personal robotic system in accordance with the present invention.

FIGS. 3A-3X illustrate various aspects of a personal robotic system in accordance with the present invention.

FIG. 4 illustrates various aspects of a personal robotic system in accordance with the present invention wherein one or more sensors may be utilized to minimize destabilizing moments applied to a mobile base.

FIG. 5 illustrates one embodiment of a process configuration in accordance with the present invention.

### SUMMARY OF THE INVENTION

One embodiment is directed to a personal robotic system, comprising: an electromechanical mobile base configured to be controllably movable upon a substantially planar surface in a global coordinate system wherein a Z axis is defined perpendicular to the substantially planar surface; a torso assembly movably coupled to the mobile base such that the torso may be controllably moved in a direction substantially parallel to the Z axis and also controllably rotated about an axis substantially perpendicular to the Z axis; a head assembly movably coupled to the torso assembly; a robotic arm operatively coupled to the torso assembly; and a controller operatively coupled to the mobile base, torso assembly, head assembly, and robotic arm, and configured to controllably manipulate nearby objects while also automatically minimizing destabilizing moments applied to the mobile base through movement of at least one of the mobile base, torso assembly, head assembly, and robotic arm. The system further may comprise a sensor operatively coupled to the controller and configured to sense one or more factors regarding an environment in which the mobile base is navigated. The sensor may comprise a sonar sensor. The sonar sensor may be coupled to the mobile base. The sensor may comprise a laser range finder. The sonar sensor may be coupled to the mobile base. The sensor may comprise an image capture device. The image capture device may comprise a 3-D camera. The image capture device may be coupled to the head assembly. The image capture device may be coupled to the mobile base. The image capture device may be coupled to the torso assembly. The mobile base may comprise a differential drive configuration having two driven wheels. Each of the driven wheels may be operatively coupled to an encoder that is operatively coupled to the controller and configured to provide the controller with input information regarding a driven wheel position. The controller may be configured to operate the driven wheels to navigate the mobile base based at least in part upon the input information from the driven wheel encoders. The controller may be configured to operate the mobile base based at least in part upon signals from the sensor. The torso assembly may be movably coupled to the mobile base such that the torso may be controllably elevated and lowered along an axis substantially parallel to the Z axis. The head assembly may comprise an image capture device. The image capture device may comprise a 3-D camera. The image capture device may be movably coupled to the head assembly such that it may be controllably panned or tilted relative to the head assembly. The robotic arm may comprise a non-electromechanical gravity compensation subsystem. The gravity compensation subsystem may comprise an at least partially compressed spring. The gravity compensation subsystem may be configured such that a load from the least partially compressed spring substantially counterbalances a gravitational load on the robotic arm. The controller may be configured to minimize destabilizing moments applied to the mobile base based at least in part upon one or more loads applied to the robotic arm. The controller may be configured to detect one or more loads based upon currents detected in one or more motors operatively coupled to the robotic arm. The system further may comprise a sensor configured to produce a signal correlated with a load applied to the robotic arm. The system may comprise a sensing element selected from the group consisting of a strain gauge, a piezoelectric crystal, a ferromagnetic element, a Bragg grating, an accelerometer, and a gyro. The system further may comprise a wireless transceiver configured to enable a teleoperating operator to remotely connect with the controller from a remote workstation, and to operate at least the mobile base.

Another embodiment is directed to a method for manipulating physical objects in a human environment, comprising: providing a personal robotic system comprising an electromechanical mobile base configured to be controllably movable upon a substantially planar surface in a global coordinate system wherein a Z axis is defined perpendicular to the substantially planar surface; a torso assembly movably coupled to the mobile base such that the torso may be controllably moved in a direction substantially parallel to the Z axis and also controllably rotated about an axis substantially perpendicular to the Z axis; a head assembly movably coupled to the torso assembly; and a robotic arm operatively coupled to the torso assembly; and operating the personal robotic system such that the robotic arm manipulates one or more nearby objects while also automatically minimizing destabilizing moments applied to the mobile base through movement of at least one of the mobile base, torso assembly, head assembly, and robotic arm. The method further may comprise providing a sensor operatively coupled to the controller and configured to sense one or more factors regarding an environment in which the mobile base is navigated. The sensor may comprise a sonar sensor. The sonar sensor may be coupled to the mobile base. The sensor may comprise a laser range finder. The sonar sensor may be coupled to the mobile base. The sensor may comprise an image capture device. The image capture device may comprise a 3-D camera. The image capture device may be coupled to the head assembly. The image capture device may be coupled to the mobile base. The image capture device may be coupled to the torso assembly. The mobile base may comprise a differential drive configuration having two driven wheels. Each of the driven wheels may be operatively coupled to an encoder that is operatively coupled to the controller and configured to provide the controller with input information regarding a driven wheel position. The controller may be configured to operate the driven wheels to navigate the mobile base based at least in part upon the input information from the driven wheel encoders. The controller may be configured to operate the mobile base based at least in part upon signals from the sensor. The torso assembly may be movably coupled to the mobile base such that the torso may be controllably elevated and lowered along an axis substantially parallel to the Z axis. The head assembly may comprise an image capture device. The image capture device may comprise a 3-D camera. The image capture device may be movably coupled to the head assembly such that it may be controllably panned or tilted relative to the head assembly. The robotic arm may comprise a non-electromechanical gravity compensation subsystem. The gravity compensation subsystem may comprise an at least partially compressed spring. The gravity compensation subsystem may be configured such that a load from the least partially compressed spring substantially counterbalances a gravitational load on the robotic arm. The controller may be configured to minimize destabilizing moments applied to the mobile base based at least in part upon one or more loads applied to the robotic arm. The controller may be configured to detect one or more loads based upon currents detected in one or more motors operatively coupled to the robotic arm. The system further may comprise a sensor configured to produce a signal correlated with a load applied to the robotic arm. The system may comprise a sensing element selected from the group consisting of a strain gauge, a piezoelectric crystal, a ferromagnetic element, a Bragg grating, an accelerometer, and a gyro. The system further may comprise providing a wireless transceiver configured to enable a teleoperating operator to remotely connect with the controller from a remote workstation, and to operate at least the mobile base.

### DETAILED DESCRIPTION

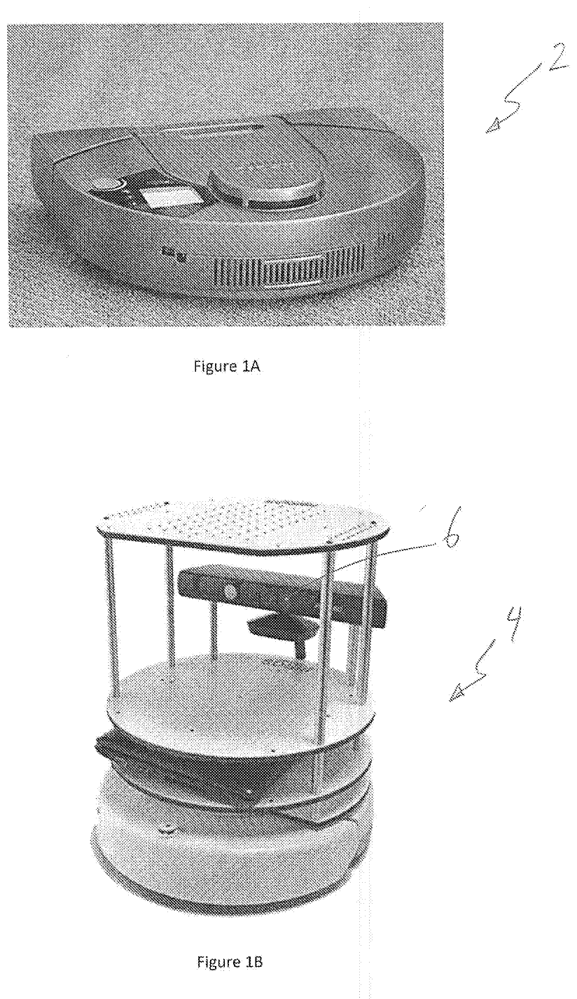

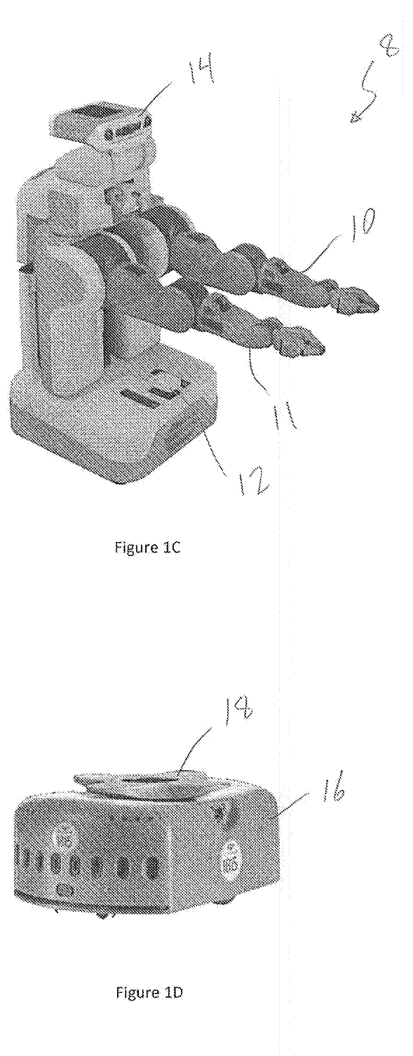

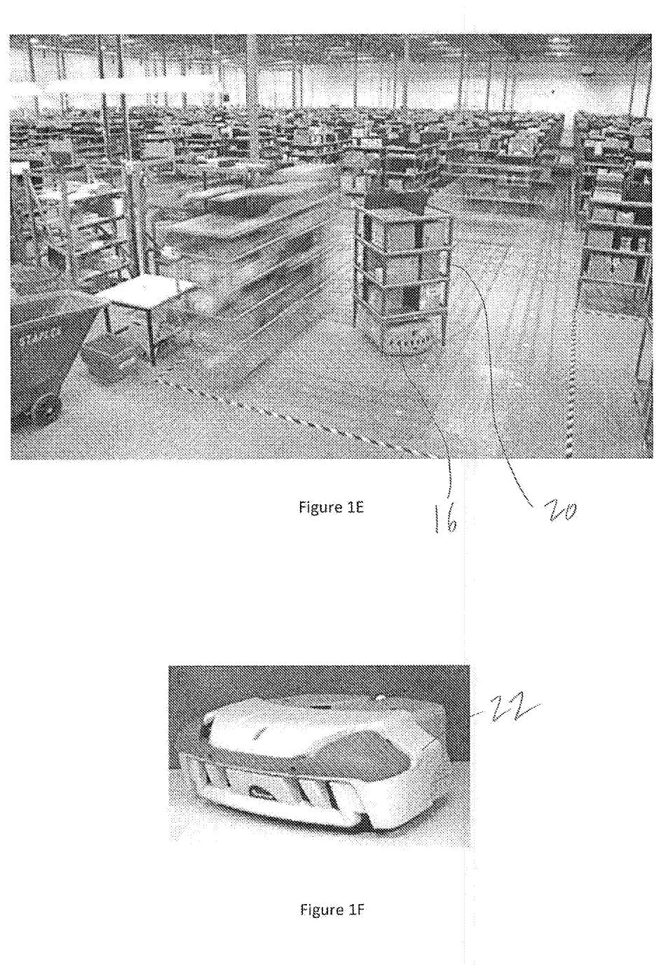

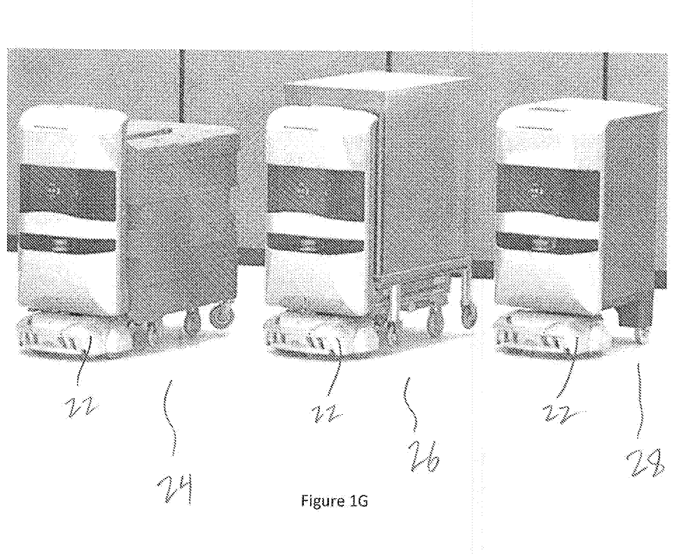

Referring to FIG. 1A, a vacuuming robot (2) is depicted which has primary function for vacuuming floors in a human environment, and has little other utility due to its design. FIG. 1B illustrates a lightweight robotics platform (4) sold under the tradename “turtlebot”® by Willow Garage, Inc., which features a 3-D camera, such as those available under the tradename Kinect® from Microsoft Corp. Such a platform may be programmed to handle light duty tasks, such as moving around a plate or two, or some lightweight tools or food. FIG. 1C illustrates a heavier duty personal robotics platform (8) sold under the tradename “PR2” by Willow Garage, Inc. This platform features two sophisticated arms (10, 11), a multi-sensor head (14), and a laser scanner (12) coupled to the mobile base component and is capable of conducting certain human-scale tasks, but is not optimized for handling inventory or bin management exercises. FIG. 1D features a small robotic system (16) sold by Kiva, Inc., which is designed to be utilized in inventorying and warehousing scenarios by virtue of a centrally-located loading interface (18), which may be utilized to lift and move large racks (20), as shown in the illustration of FIG. 1E. FIG. 1F features a tug-style robotic system (22) sold under the tradename “tug”® by Aethon, Inc., which may be utilized to pull various types of loads, as shown in the three embodiments (24, 26, 28) depicted in FIG. 1G. As noted above, none of these robotic systems is optimized for handling and managing bins of objects at the human scale which may be shelved, stored, and moved to various locations within a human environment to save manual labor trips for completing such tasks.

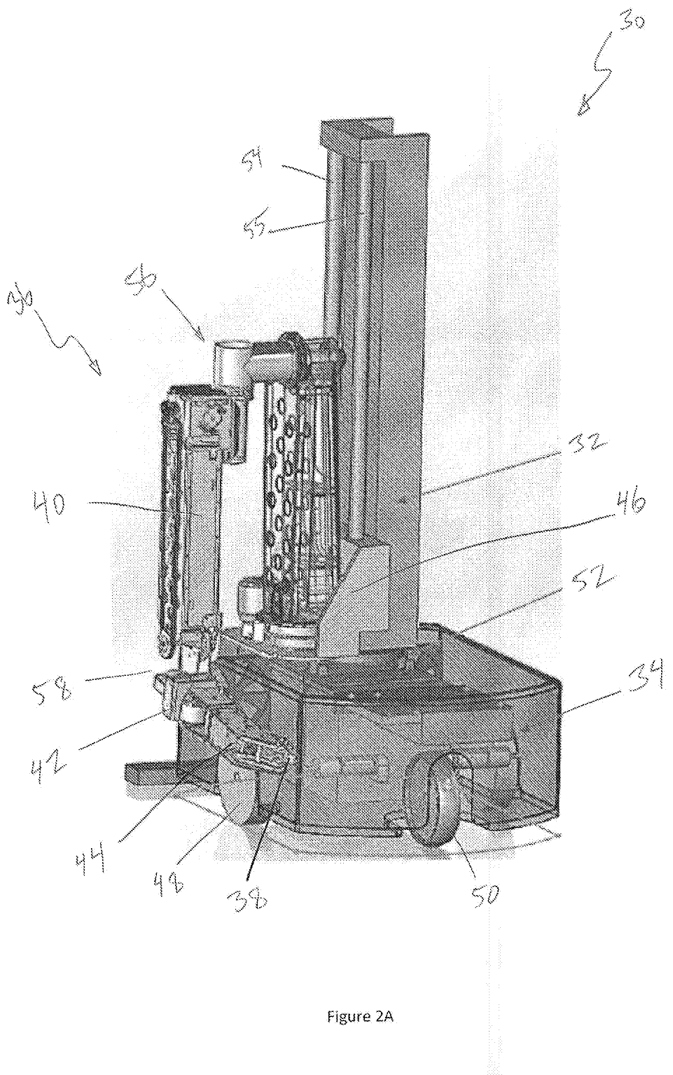

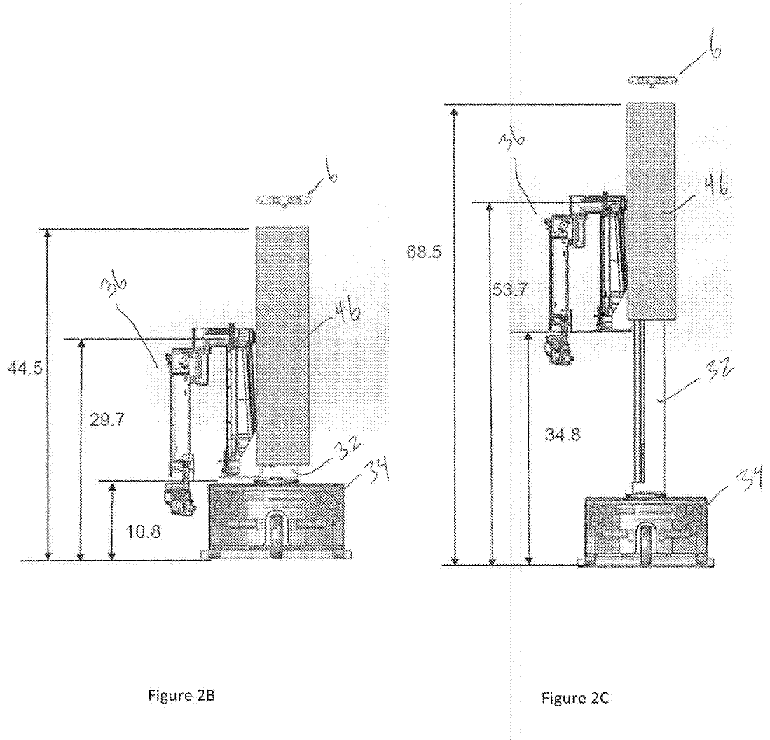

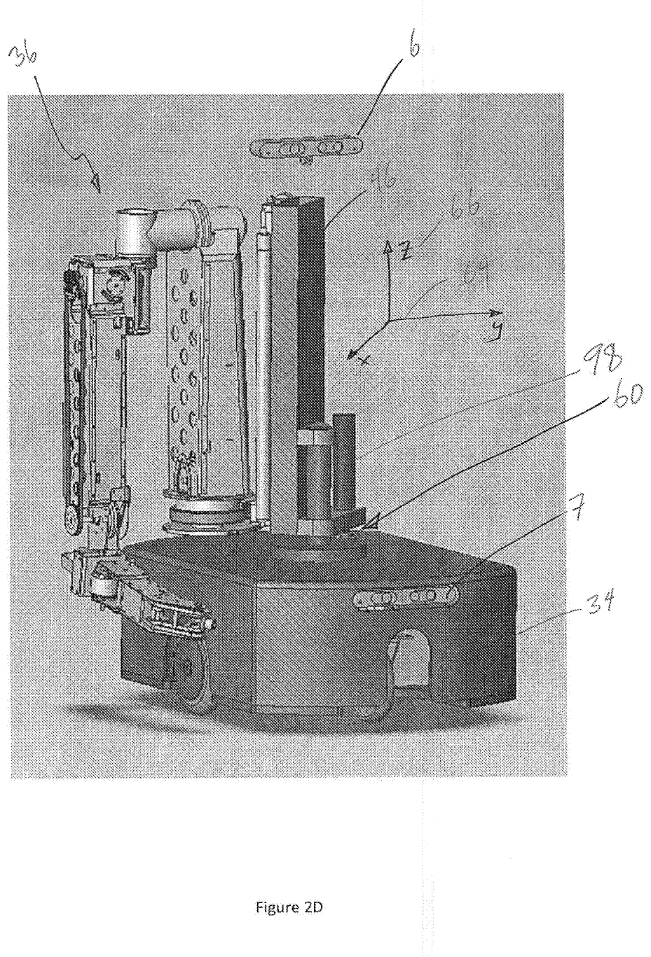

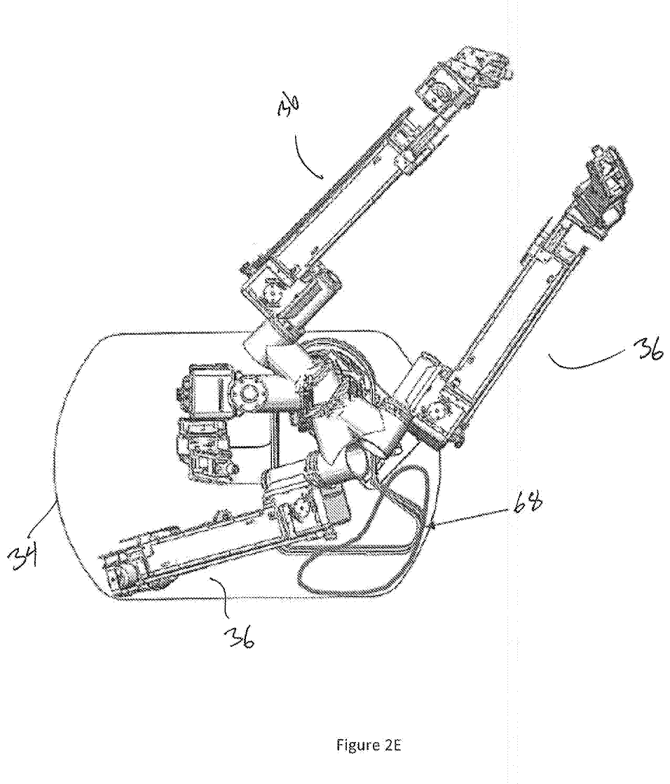

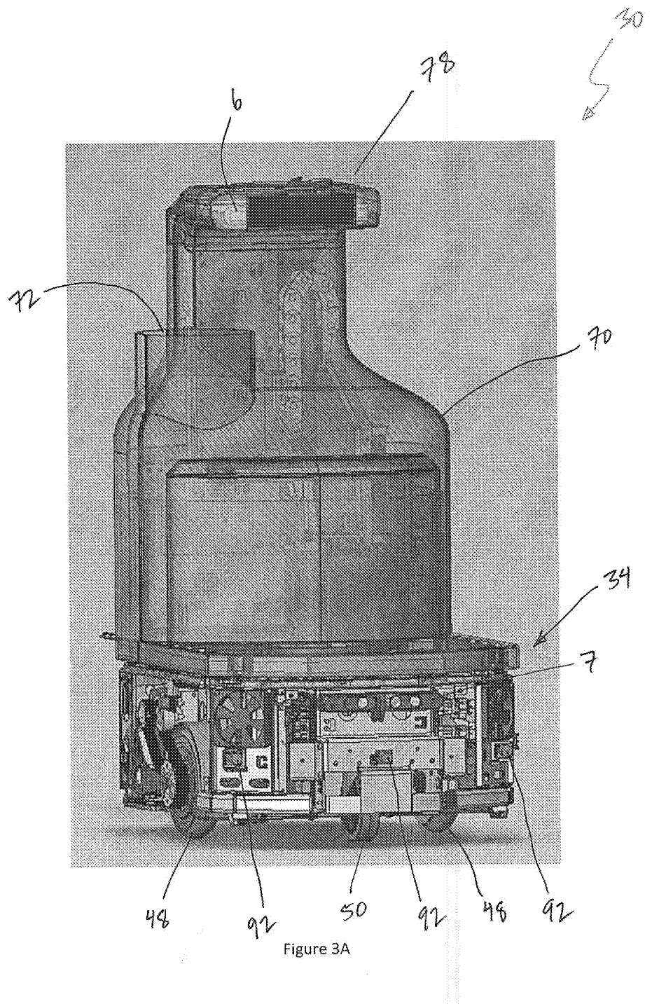

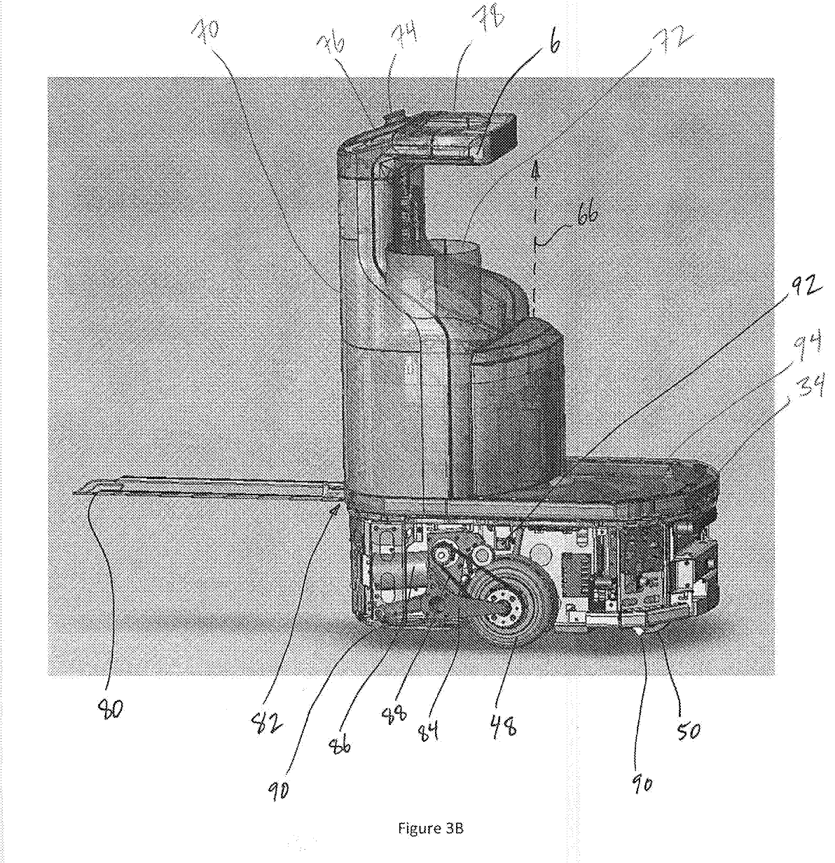

Referring to FIGS. 2A-2E, various aspects of a desirable robotic system design are illustrated. Referring to FIG. 2A, an electromechanically mobile base (34) comprising a plurality of motors operatively coupled to a plurality of driven wheels (48) may be utilized to affirmatively move the mobile base (34), while one or more passive wheels (50), such as trailing casters, may be utilized to stabilize the mobile base (34) on a substantially planar surface, such as a floor. A torso assembly may be movably coupled to the mobile base (34) with a configuration selected to maximize the utility of an associated robotic arm assembly (36) such that the entire arm assembly (36) may be controllably elevated and lowered relative to the mobile base (34) with an electromechanical elevation configuration such as a motor-pulley elevation/lowering arrangement stabilized by one or more structural shafts (54, 55) about which linear bearings may be intercoupled to allow the elevating coupling platform (46) to move smoothly up and down while also supporting the intercoupled robotic arm assembly (36). The robotic arm assembly (36) preferably has multiple degrees of freedom provide by joints, such as in the depicted configuration wherein a shoulder coupling provides pitch and yaw degrees of freedom; an upper arm assembly (40) is movably coupled to a forearm assembly (42) by a movable elbow coupling (58) preferably having both pitch and yaw degrees of freedom; a wrist assembly (44) is coupled to the forearm assembly (42) to provide one or more degrees of freedom (such as pitch and roll via a differential drive configuration as described below) between a grasper or other tool mounted at a tool interface (38). Further, the torso assembly preferably is controllably movable relative to the mobile base assembly, such as by an electromechanically-actuated roll axis coupling (52) that facilitates roll in either direction about an axis that may be parallel to the Z axis illustrated in FIG. 2D (element 66).

Referring to FIGS. 2B and 2C, sample dimensions in inches for major elements of a robotic system embodiment are illustrated to show that a relatively small electromechanically movable base (in the range of about 24 inches wide by about 30 inches long) may be utilized to provide a relatively large range of gripper or other tool motion with an elevatable torso configuration; such utility may be even further enhanced with a controllable roll degree of freedom wherein the torso may be controllably rolled relative to the movable base, carrying with it the arm assembly, as depicted further in FIG. 2D.

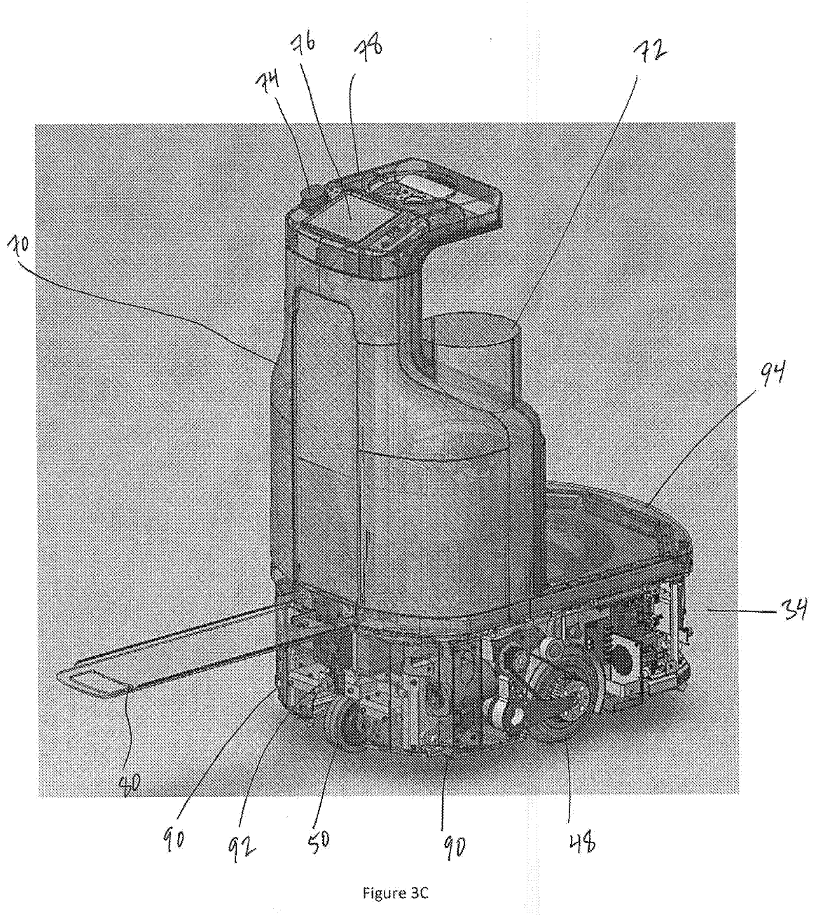

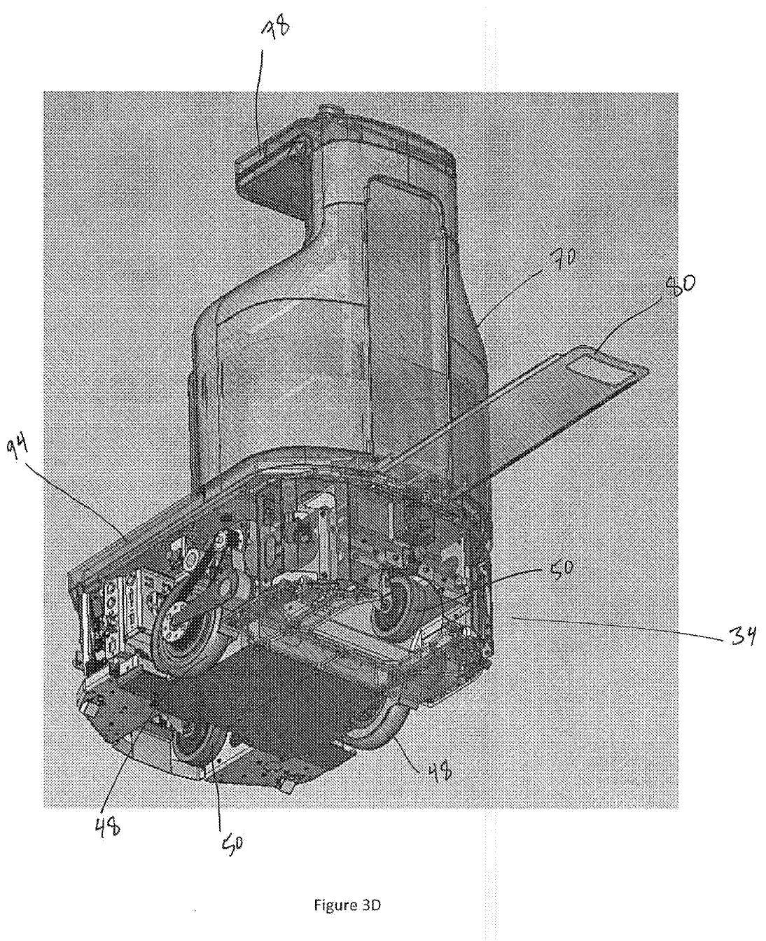

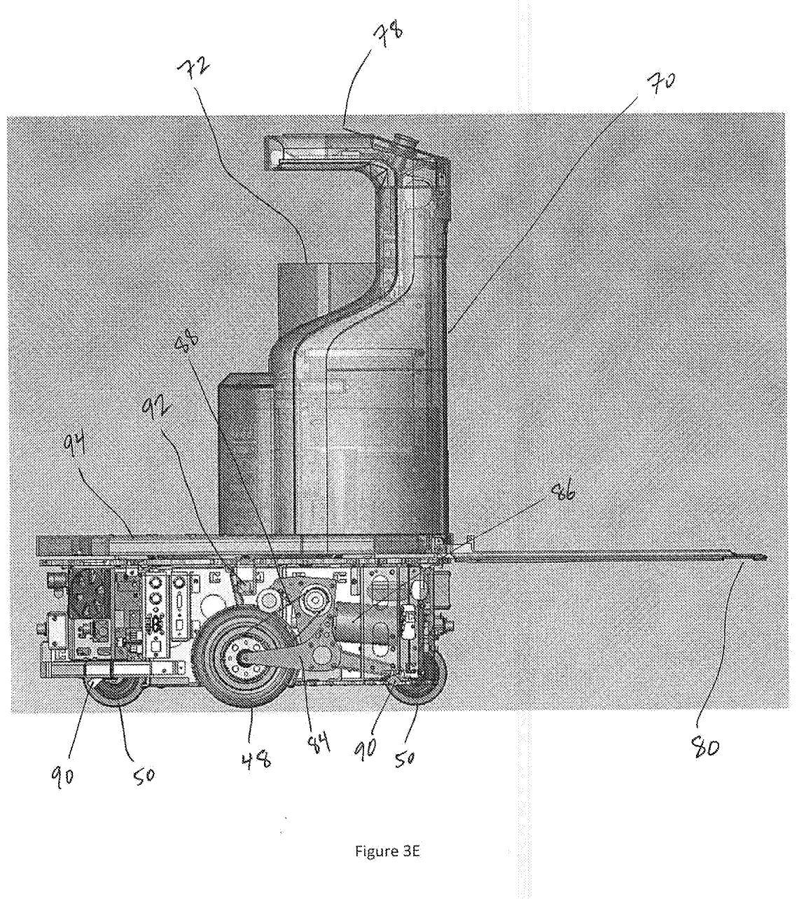

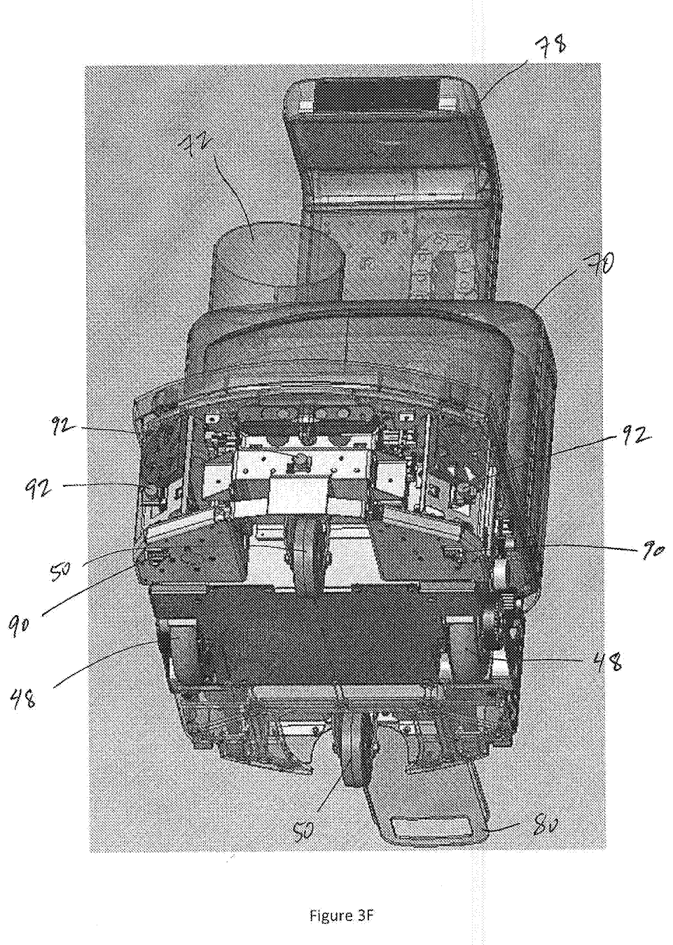

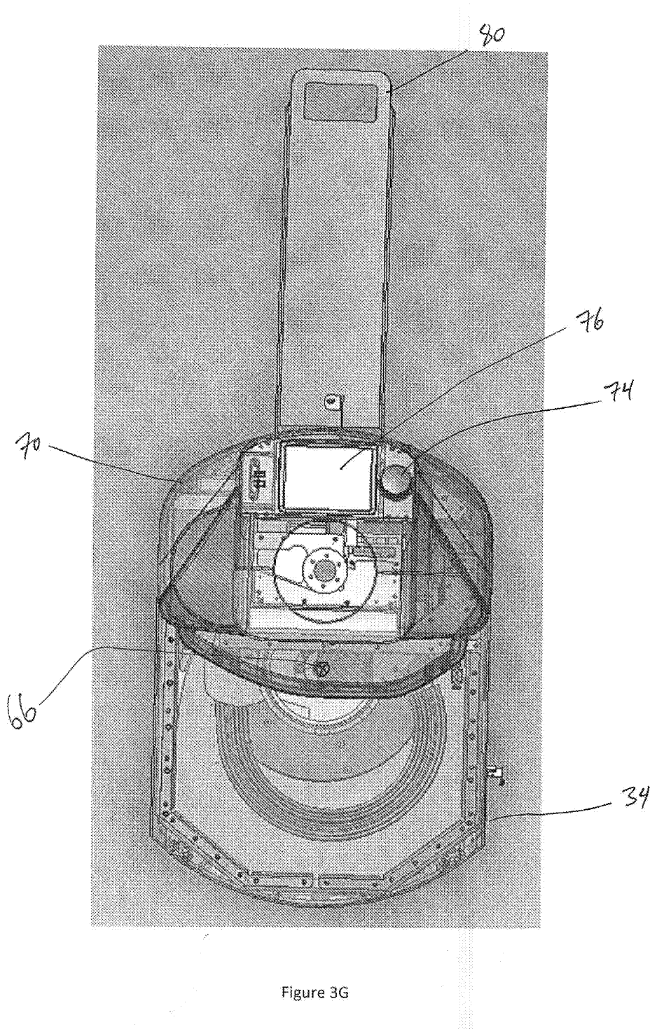

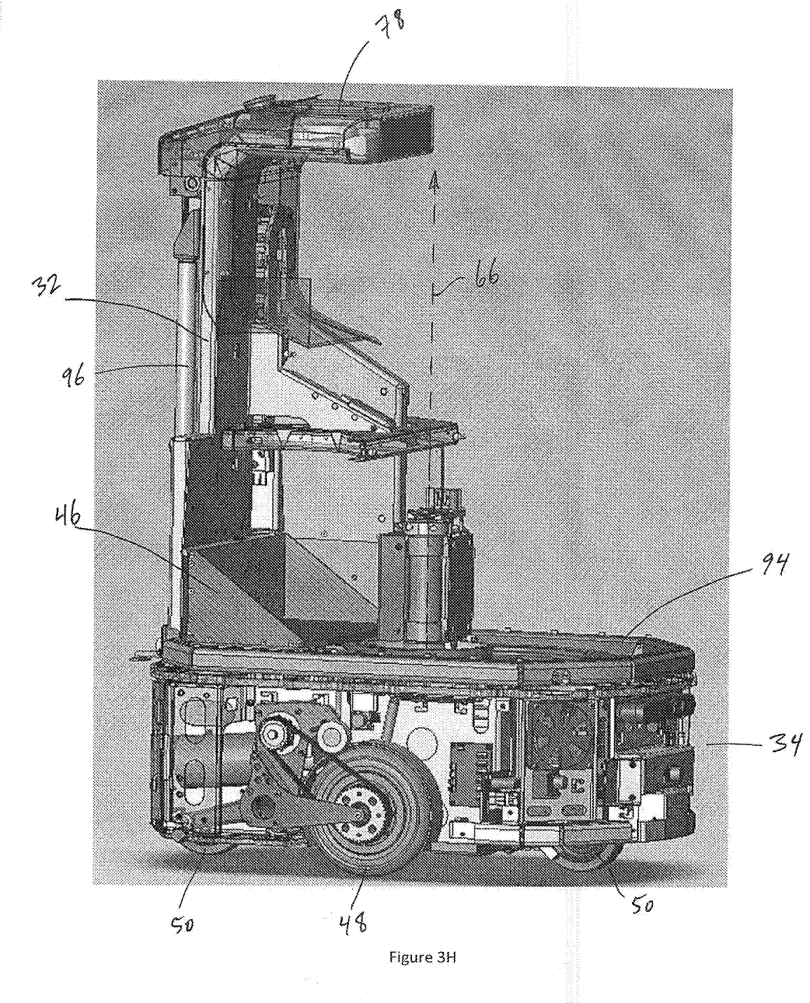

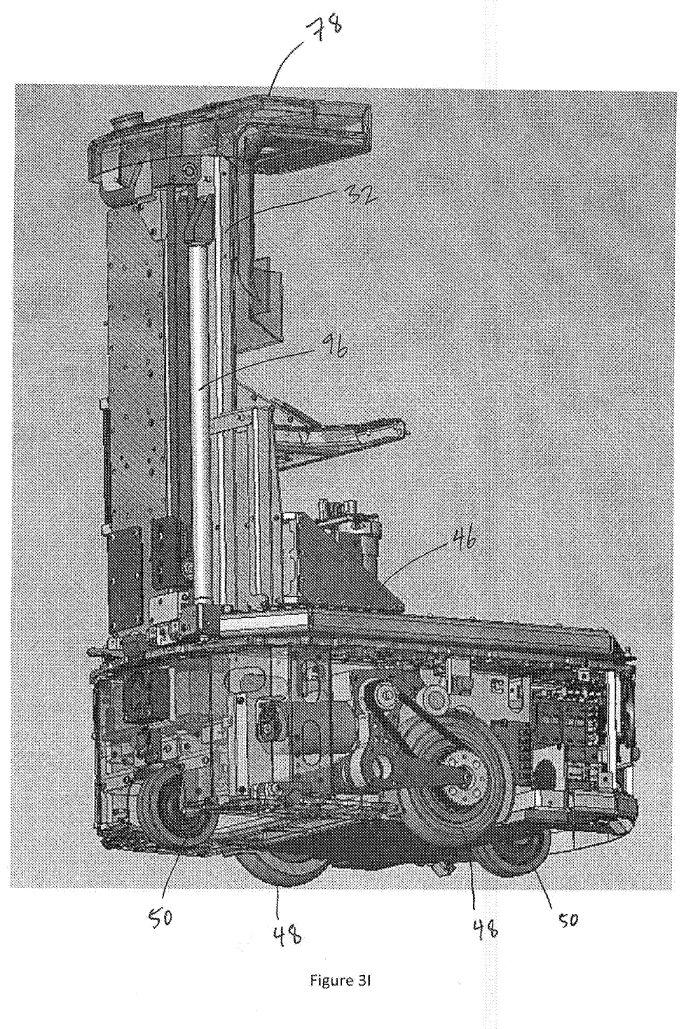

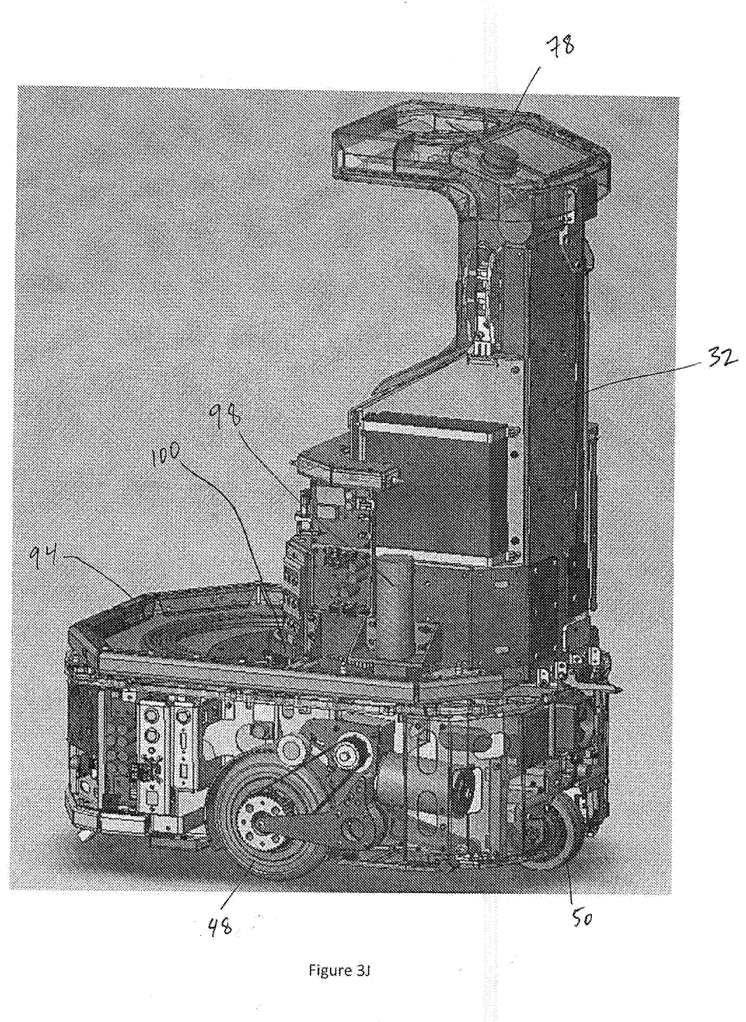

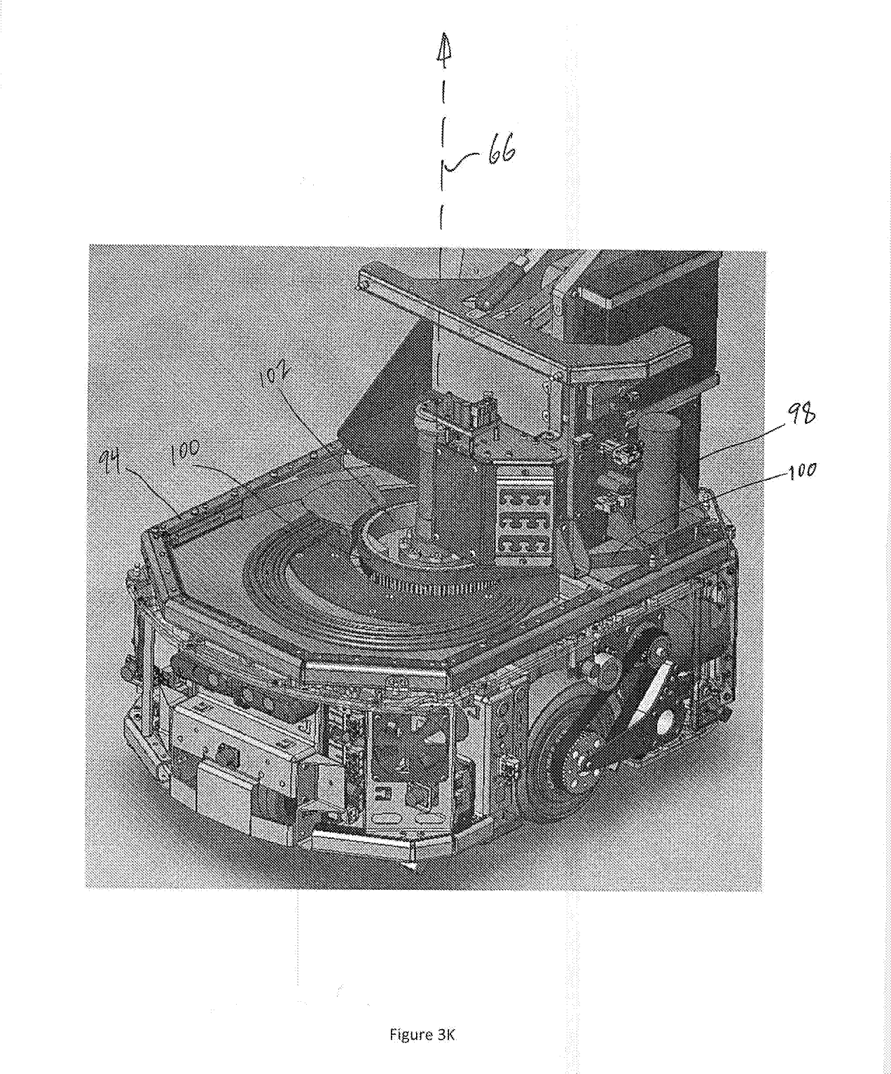

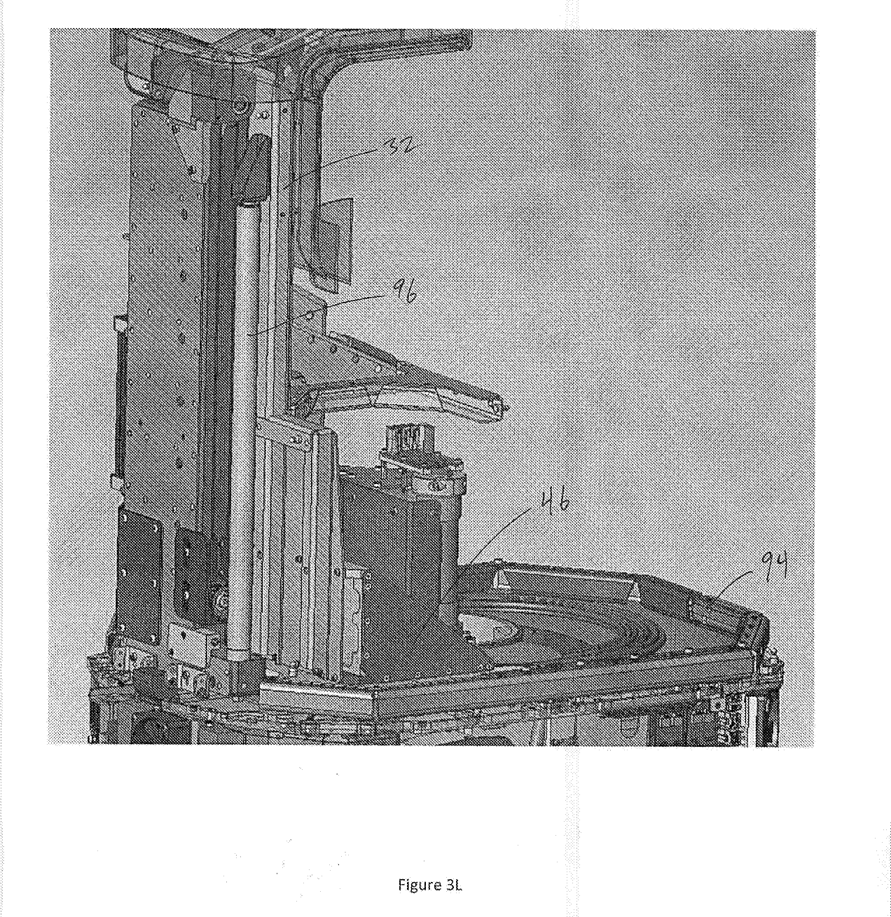

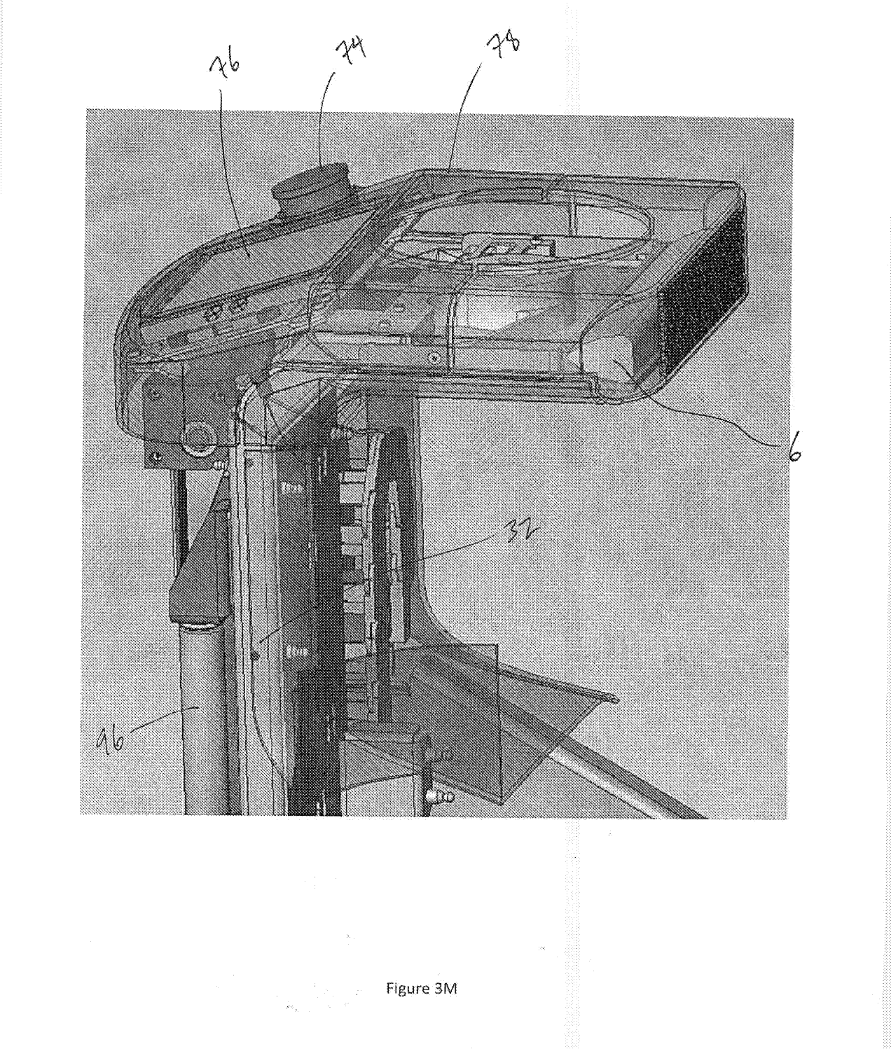

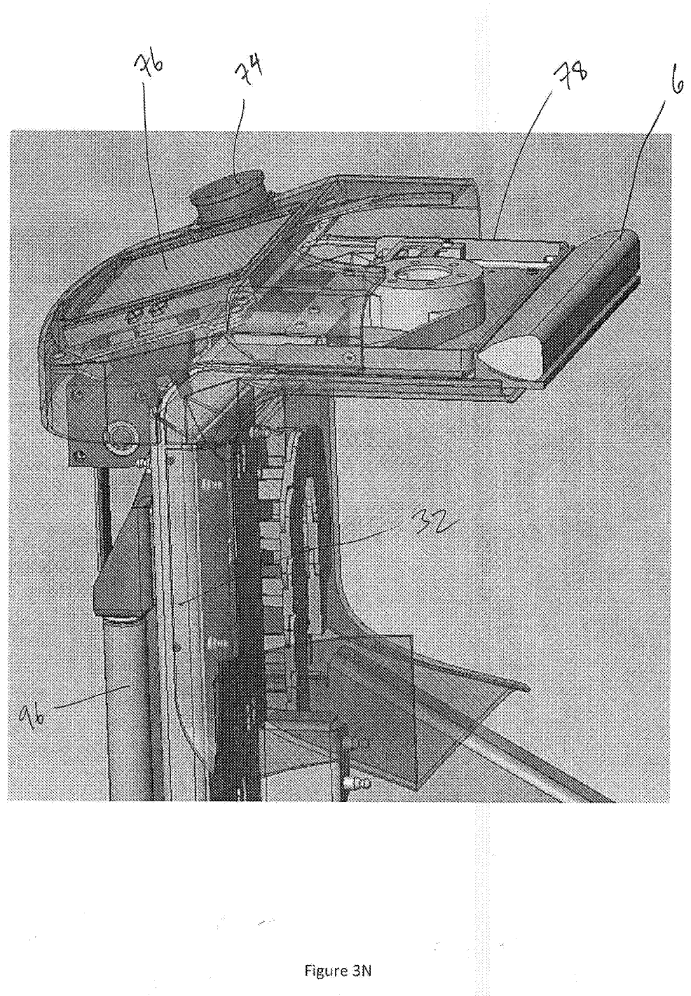

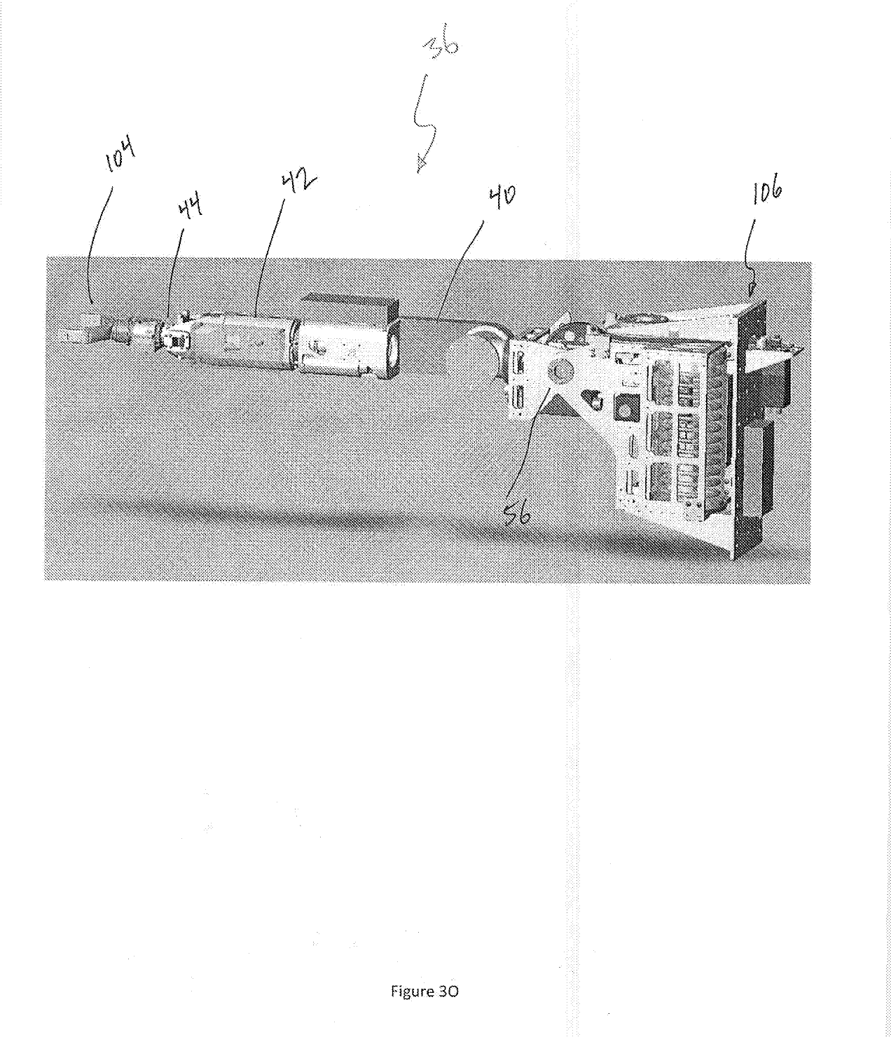

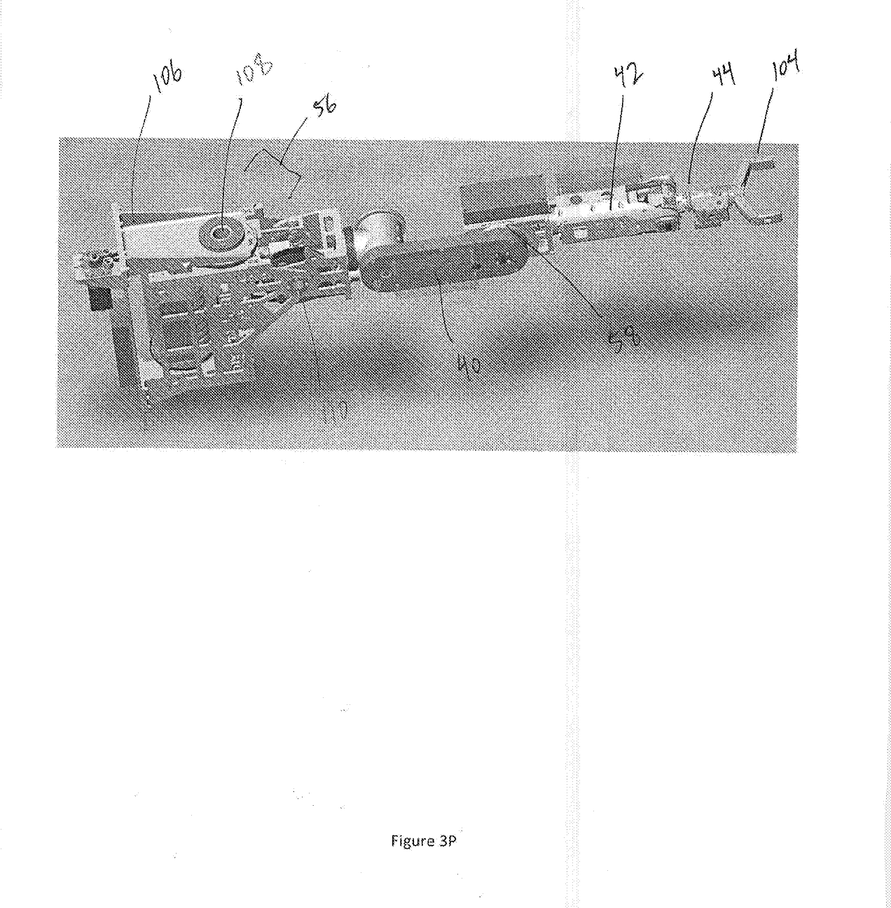

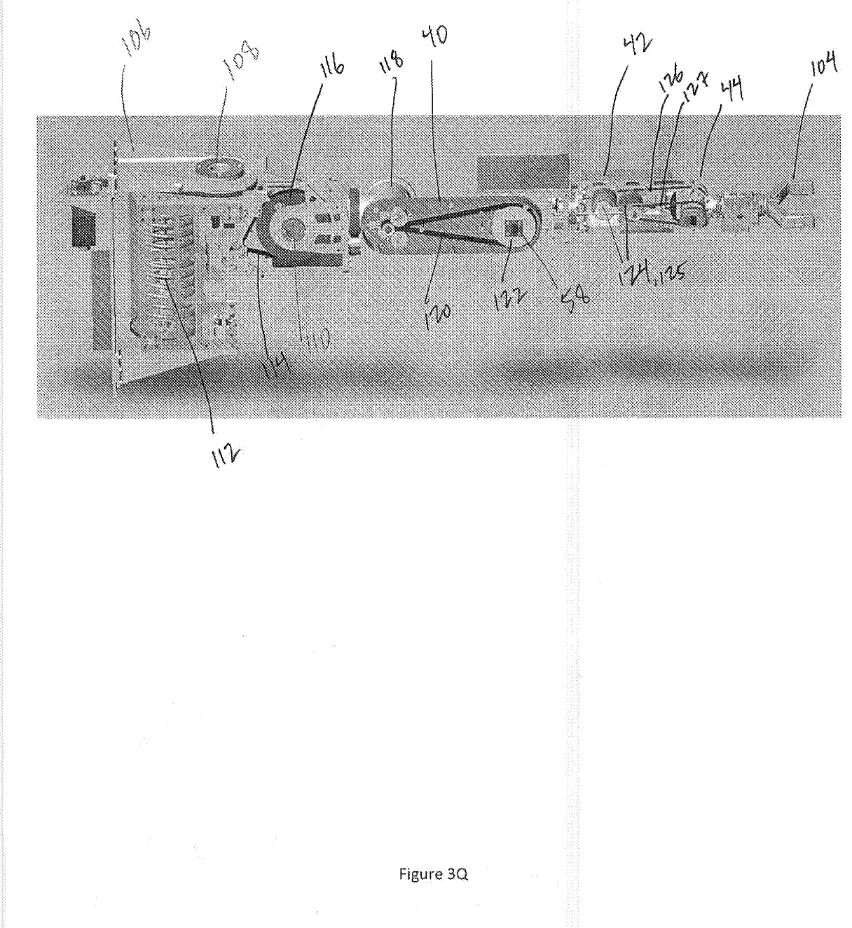

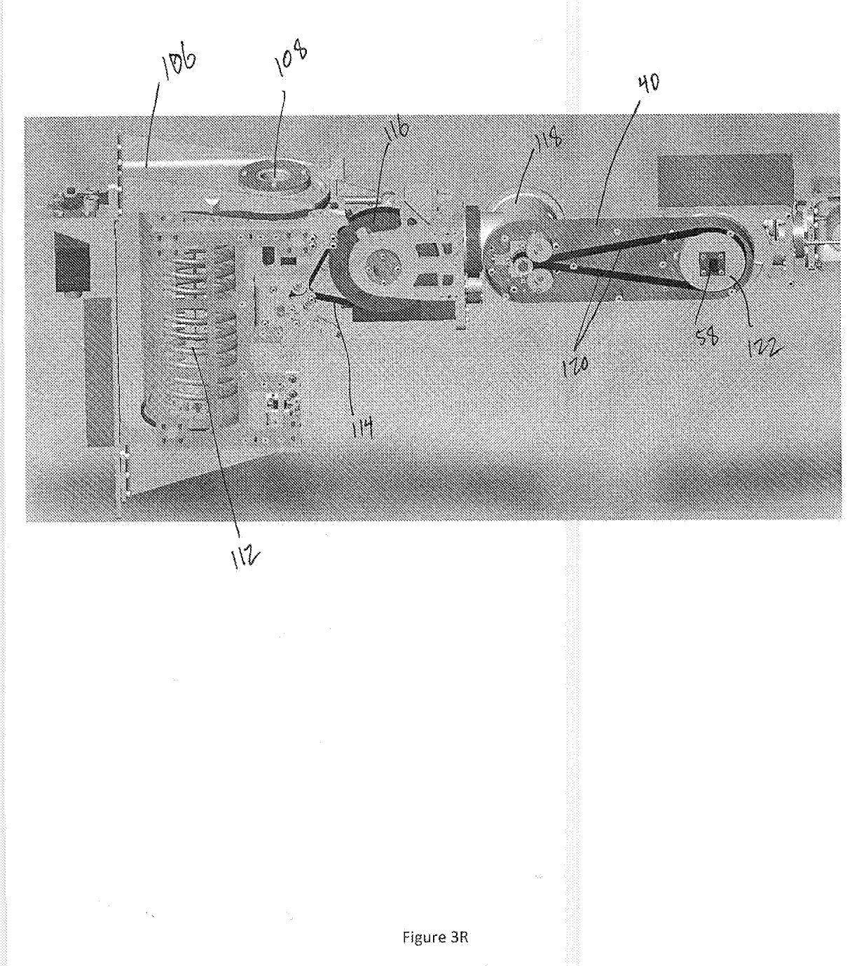

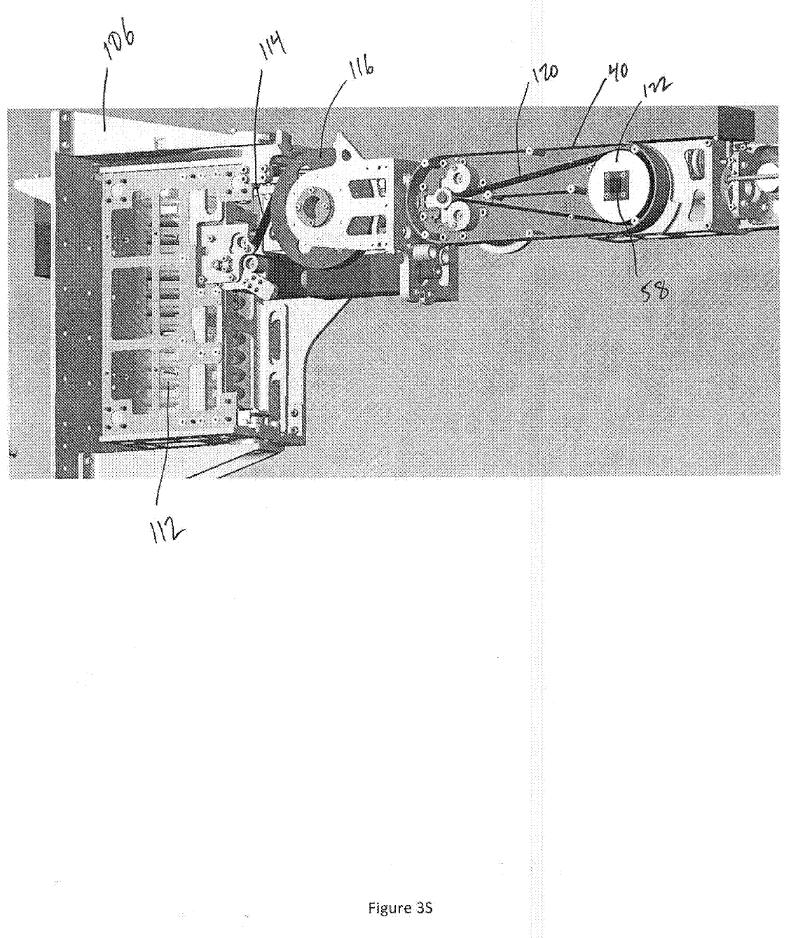

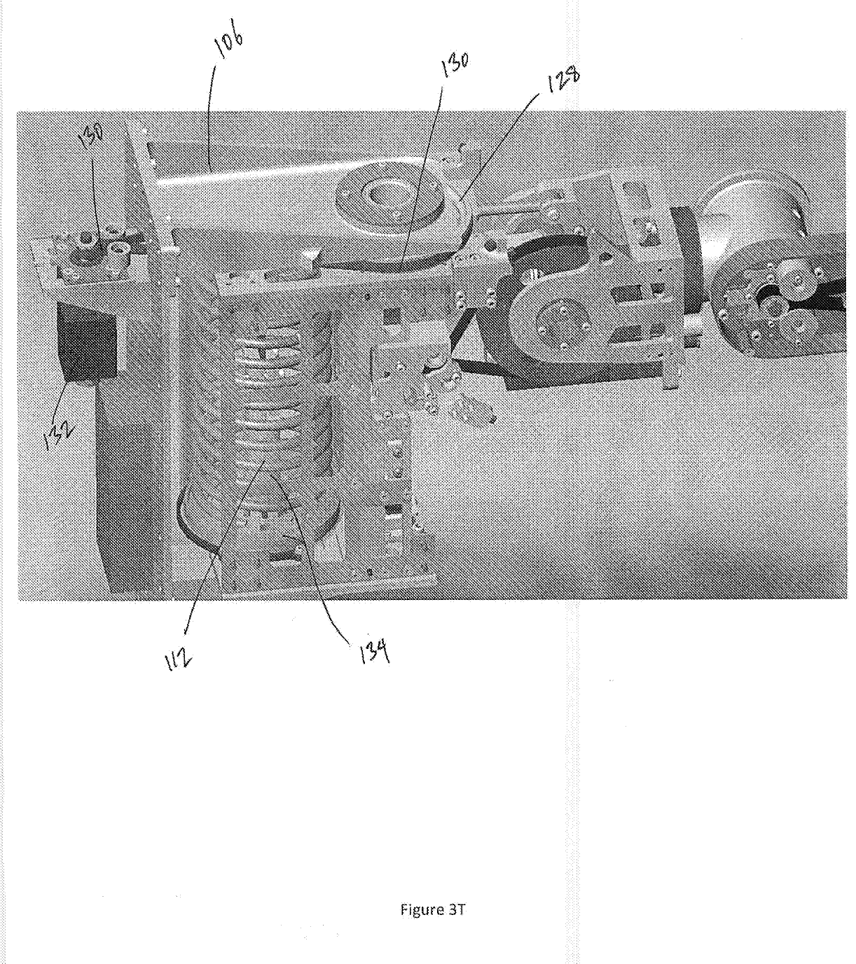

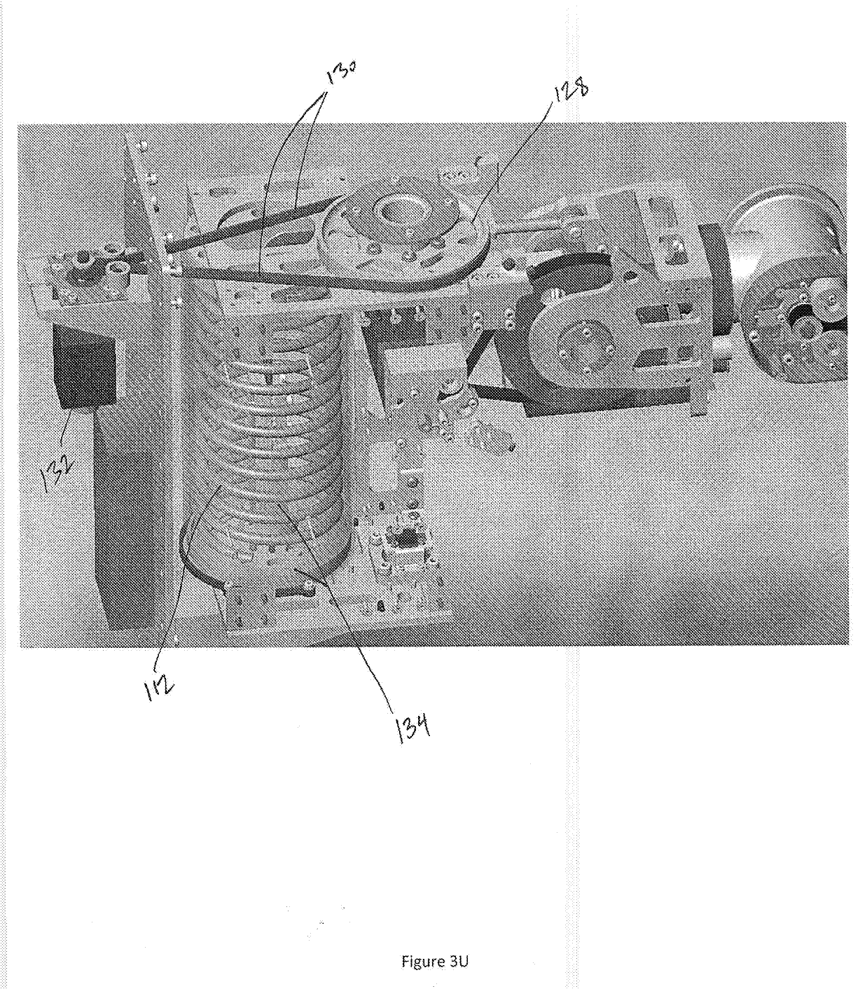

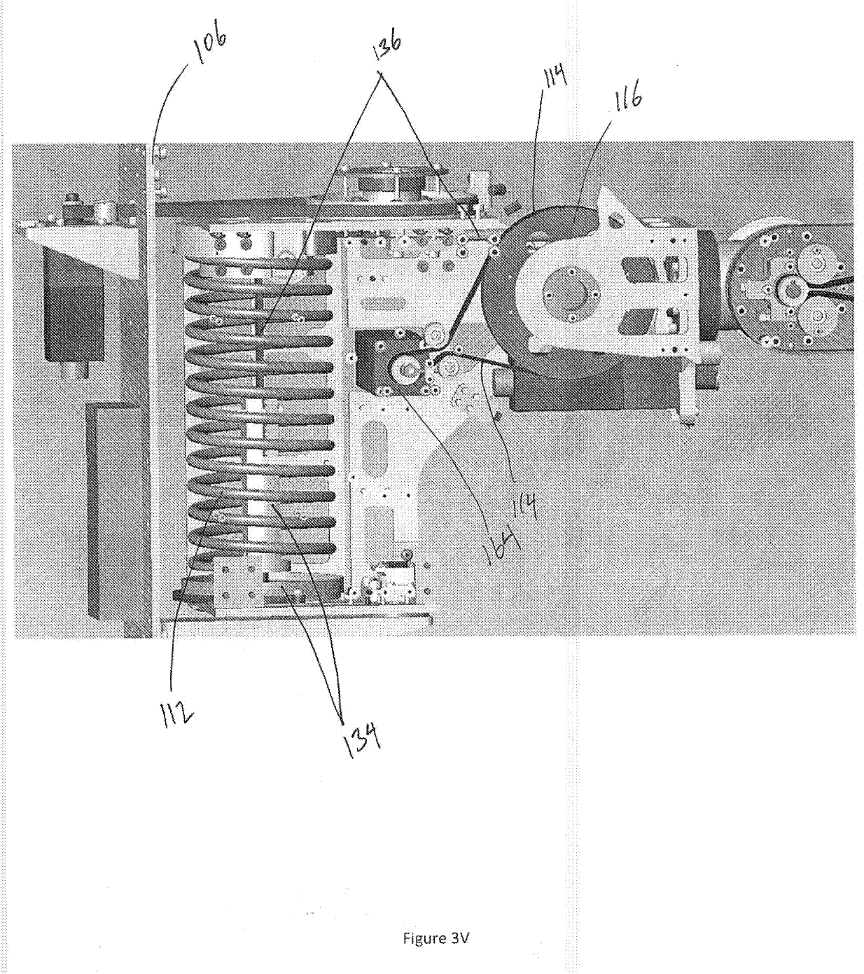

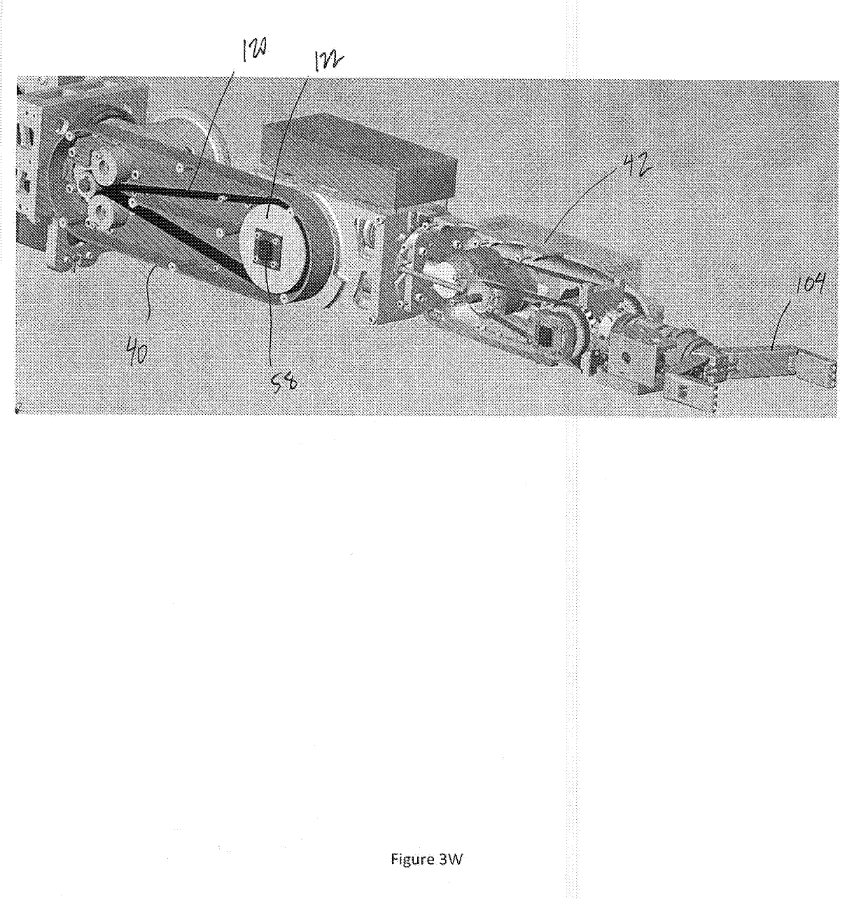

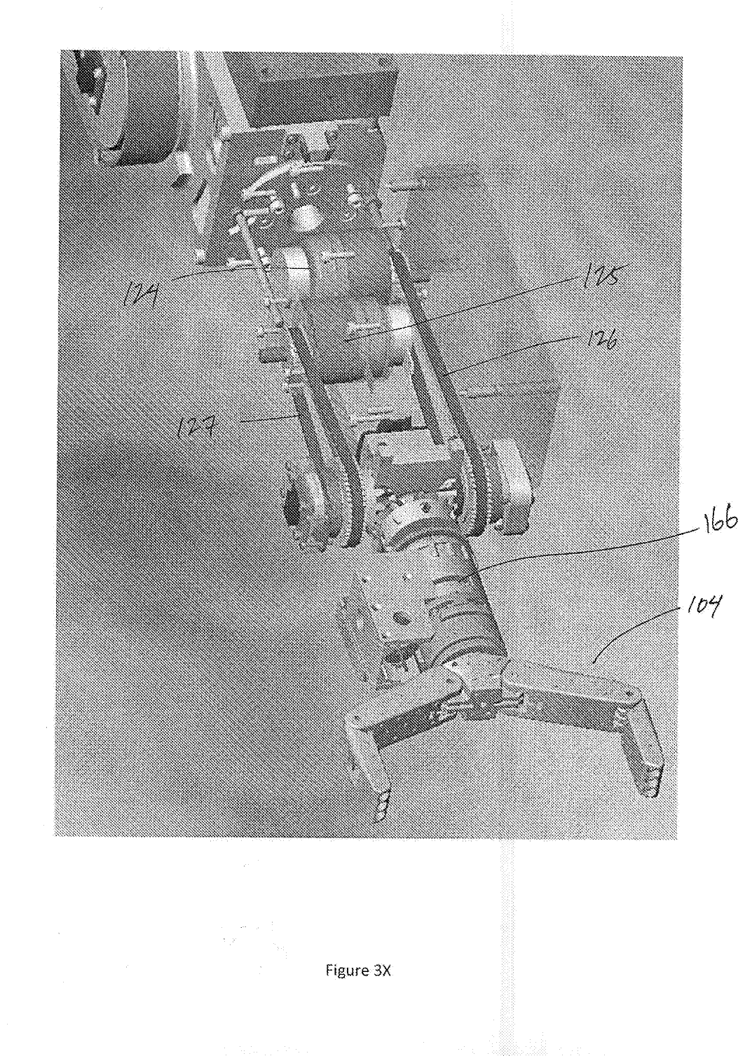

Referring to FIG. 2D, the torso coupling platform and associated hardware (46; including the robotic arm assembly 36) may be rotatably coupled to the movable base assembly (34) using a roll coupling assembly (60) that may comprise one or more heavy duty bearings about a main shaft, with a roll actuation motor (98) intercoupled by a belt (element 100, as described below). Also shown is a three-dimensional depth camera (6), such as that available from Primesense, Asus, or Microsoft (under the tradename Kinect®) which may be movably coupled to the torso (such as by a configuration wherein the camera 6 is movably coupled to a head assembly that is fixedly coupled to a torso assembly; or by a configuration wherein a camera 6 is fixedly coupled to a head assembly that is movably coupled to a torso assembly; or by a configuration wherein a a camera 6 is movably coupled to a head assembly that is movably coupled to a torso assembly). FIG. 2D features a global coordinate system (64) wherein the X and Y coordinates form a plane that may be substantially parallel or coplanar with the surface (i.e., a floor) upon which the mobile base (34) is navigated. Preferably the torso assembly is rotatably coupled to the mobile base about an axis that is substantially parallel with the depicted Z axis, or substantially co-axial with the Z axis 66 depicted in FIGS. 3B, 3G, 3H, or 3K). FIG. 2E illustrates that the roll degree of freedom for the torso and intercoupled robotic arm assembly (36) allows for a broad range of robotic arm reach about the mobile base, while certain spaces, such as that marked by element 68 in FIG. 2E, may be left to be occupied by nonrotating vertical structures, such as one or more torso support members.

Referring to FIGS. 3A-3X, more detailed robotic system assemblies in accordance with the present invention are depicted in various states of disassembly for illustrative purposes. Referring to FIGS. 3A-3G, in one embodiment the mobile base assembly (34) may comprise a differential drive configuration with two opposing actively-driven wheels (48) and one or two passive wheels (50, such as low-friction casters). The driven wheels (48) may be operatively coupled to drive motors (86) using drive belts (88). Rotatable suspension members (84) may be configured to provide the driven wheels (48) with suspension play, such as about 1-2 inches of suspension play that may be dampened with an intercoupled spring-loaded tubular damper member akin to a motor vehicle wheel suspension configuration. The mobile base preferably houses a power supply, such as a DC battery, as well as power inverters, one or more computing systems or controllers, and various sensors. For example, the depicted embodiment comprises a motor controller board for controlling each motor; the motor controller boards may have gryos and/or accelerometers built in to provide sensing data local to these platforms. Additionally, one or more encoders, such as optical or magnetic encoders, may be operatively coupled to each movable joint, such as motor drive axles, wheel axles, or the like, so that the controllers may be kept apprised of motor position (and/or system position relative to the global coordinate system based upon known geometry and conventional. traction assumptions). Motor currents generally also may be sensed and utilized to determine motor torque and provide other information back to the controller which may be useful in determining errors, navigation issues, and the like. The depicted embodiment features four downward-facing infra-red proximity sensors (90), as well as a plurality of outward-facing sonar range finder sensors (92), all of which preferably are operatively coupled into the main computer or controller so that associated data may be utilized to understand the environment, and avoid obstacles such as walls, people, and stairways (or other holes in the floor that may present falling/balancing hazard for the electromechanically mobile base 34).

The torso may be substantially enclosed or surrounded using a single or multipart housing (70) which may have a chimney-shaped opening (72) to accommodate passage of a robotic arm assembly. As described above, a head assembly (78) may be either fixedly or movably coupled to the torso, and components therein may be fixedly or movably coupled to the head assembly. FIG. 3N illustrates a configuration wherein a 3-D camera sensor assembly (6) such as that available under the tradename Kinect® may be movably coupled to a head assembly (78) that is fixedly or movably coupled to a torso assembly using a simple motor/belt-driven tilt configuration, or a more complex pan+tilt configuration featuring two extra controllably degrees of freedom between the head assembly (78) and the camera sensor assembly (6). The depicted head assembly may also feature a small display (76) for nearby operator input and feedback, such as a touchscreen display. Further, an emergency stop button (74) may be prominently featured as part of the head assembly (78) to facilitate easy access. Also shown, particularly in FIGS. 3B-3G, is a handle assembly (80) which may be configured to have a latch (82) that operates to unlock (i.e., allow free rotation of) the torso/arm roll degree of freedom, so that the torso may be freely rotated by an operator when the handle (80) is in the fully extended configuration, such as is illustrated in FIG. 3B. The latch (82) also may be intercoupled with the differential drive control such that opening of the handle (80) to a certain extend places the driven wheels in a freewheeling configuration—so an operator may not only rotate the torso/arm roll degree of freedom to move the torso and/or arm around relative to the mobile base—but also move the mobile base around by simply applying loads (i.e., pulling) to the handle (80). The bottom of the torso assembly may be formed into a deck assembly (94) that essentially forms a lid over the movable base below, and also a shelf for placing items upon, such as with the robotic arm. The shelf portion may be fitted with one or more small containers with one or more wall structures to assist with containment of items such as those that have been gathered using the robotic arm, items to be transported and placed, and/or the robotic arm itself when not in use.

FIGS. 3H-3N illustrate further deconstructed views of a similar robotic system. Referring to FIG. 3H, with the torso housing removed, the elevating/lowering robotic arm coupling platform (46) is visible, as is the main torso structural member (32) and an associated gas gravity-counterbalancing shock (96) configured to operate somewhat akin to the manner in which similar structures are utilized to compensate for gravity with heavy motor vehicle trunk or hood lids. A torso roll axis (66) is illustrated with a torso roll motor (98) and intercoupled drive belt (100) looped from a motor drive pulley around a large driven pulley (102) to provide further gear reduction (the motors typically also feature integrated gearbox hardware which may be selected to have particular gear reduction ratios; for example, motors such as those available from Maxon of Switzerland typically have an intercoupled gearbox which may be selected to have various mechanical configurations such as spur, planetary, ball screw, and the like) in rolling the torso and associated robotic arm and head assemblies. FIG. 3N illustrates a configuration with the head assembly housing removed to illustrate intercoupling of a 3-D camera assembly (6), as described above.

Referring to FIGS. 3O-3X, various aspects of a robotic arm configuration suitable for intercoupling with the robotic system componentry described in reference to FIGS. 3A-3N are illustrated. Referring to FIG. 3O, a robotic arm assembly (36) is illustrated with a proximal torso mounting frame assembly (106) that houses a compressed spring (112) which may be utilized to mechanically counterbalance the arm relative to gravity, similar to a manner in which the robotic arm embodiments of U.S. patent application Ser. No. 12/626,187, which is incorporated by reference herein in its entirety, may be mechanically counterbalanced. The arm assembly (36) may comprise a shoulder joint assembly (56) having a shoulder pitch joint axis (110) and a shoulder yaw axis (108); the shoulder assembly may be operatively coupled to an upper arm assembly (40), which may be operatively coupled to a forearm assembly (42), which may be coupled to a tool, such as a gripper (104), with a wrist assembly (44), such as one that comprises a dual-motor (124, 125), dual drive-belt (126, 127) differential drive configuration, such as that shown in FIG. 3X, to enable wrist pitch and wrist roll degrees of freedom. Shoulder pitch may be actuated with a drive motor (164, as shown in FIG. 3V) coupled to a shoulder pitch driven pulley (116) via a belt (114). Referring to FIG. 3V, the shoulder pitch driven pulley (116) may also be operatively coupled (i.e., via a belt 136) to a spring compression anchor assembly (134) configured to controllably compress the spring (112) and therefore apply counterbalancing loads to the shoulder pitch driven pulley (116) that are designed to provide gravity compensation to the arm assembly (36). FIG. 3T illustrates that a shoulder yaw drive motor (132) may be intercoupled to a driven pulley (128) by a belt (130). As shown in FIG. 3R, the elbow joint pitch degree of freedom (axis 58) may be driven by a motor (118) intercoupled with a driven pulley (122) by a drive belt (120). FIG. 3X illustrates a differential drive wrist assembly, as described above, with an intercoupled grasping actuation assembly (166) which may either transfer a motion actuation from the wrist assembly, or may comprise a grasp drive control motor.

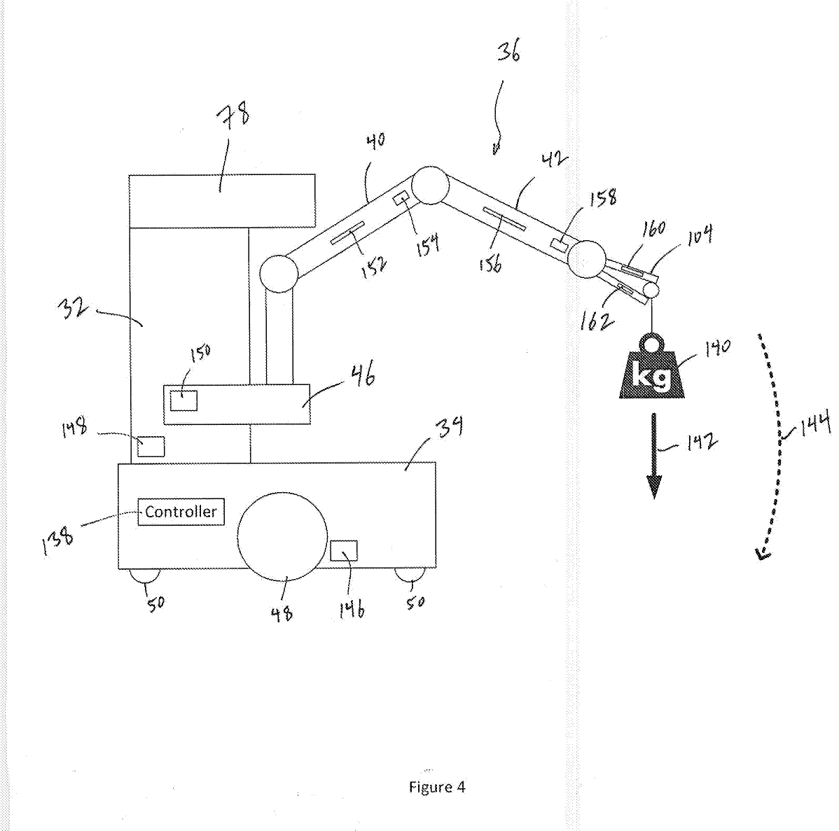

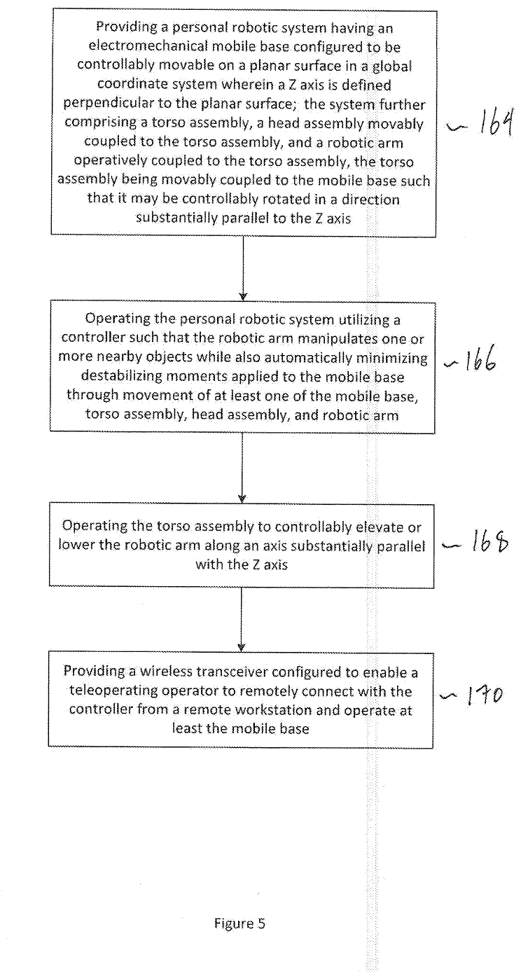

Referring to FIG. 4, a schematic view of a robotic system featuring componentry as described above in relation to FIGS. 2A-3X is illustrated, with additional sensors intercoupled to provide additional stability functionality. As shown in FIG. 4, sensors (146, 148, 150, 152, 154, 156, 158, 160, 162) comprising components such as a strain gauge, a piezoelectric crystal, a ferromagnetic element, a Bragg diffraction grating (such as those available from Luna Innovations, Inc.), an accelerometer, and/or a gyro may be coupled to many aspects of the robotic system to improve the level of information provided to the controller (138) so that the controller may be programmed to maximize stability of the entire robotic assembly in various scenarios, such as the one depicted wherein the robotic system is carrying a mass (140) which creates a moment (144) due to the gravitational load (142) associated with the mass (140). For example, in one embodiment, once a mass (140) such as that depicted in FIG. 4 has been grasped, the controller may be configured to bring the mass closer to the torso; further, or alternatively, the controller may be configured to bring the mass closer to the ground by lowering the mass with the arm and/or lowering the torso to which the arm is coupled; further, or alternatively, the controller may be configured to rotate the electromechanically mobile base (34) relative to the torso (32) to maximize stability resistance to the moment coming from the mass (140) through the arm (i.e., if the torso is rectangular and/or having one wheel-stabilized dimension longer than the perpendicular one in the plane of the floor upon which it is resting, the controller may be configured to align the moment from the arm/mass with the best wheel-stabilized moment resisting mobile base orientation); further, or alternatively, the controller may be configured to decrease the maximum joint velocities at one or more of the joints of the overall system may be limited (for example, in one embodiment, with a mass loaded onto the arm, joint velocities of the arm joints, torso movement joints/axes, and/or wheel actuation joints/axes may be limited to reduce impulse loading and linear/angular acceleration/deceleration loads; in other words, the controller may optimize joint velocities to prevent the system from jerking around the mass or causing large destabilizing loads/moments). Referring to FIG. 5, one such configuration is illustrated, wherein a personal robotic system is provided having an electromechanical mobile base configured to be controllably movable on a planar surface in a global coordinate system wherein a Z axis is defined perpendicular to the planar surface; the system further comprising a torso assembly, a head assembly movably coupled to the torso assembly, and a robotic arm operatively coupled to the torso assembly, the torso assembly being movably coupled to the mobile base such that it may be controllably rotated in a direction substantially parallel to the Z axis (164). As described above, the personal robotic system may be operated using a controller such that the robotic arm manipulates one or more nearby objects while also automatically minimizing destabilizing moments applied to the mobile base through movement of at least one of the mobile base, torso assembly, head assembly, and robotic arm (166). In one embodiment, the torso assembly may be operated to controllably elevate or lower the robotic arm along an axis substantially parallel with the Z-axis. In one embodiment, a wireless transceiver may be provided that is configured to enable a teleoperating operator to remotely connect with the controller from a remote workstation and operate at least the mobile base (170).

Various exemplary embodiments of the invention are described herein. Reference is made to these examples in a non-limiting sense. They are provided to illustrate more broadly applicable aspects of the invention. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. Further, as will be appreciated by those with skill in the art that each of the individual variations described and illustrated herein has discrete components and features which may be readily separated from or combined with the features of any of the other several embodiments without departing from the scope or spirit of the present inventions. All such modifications are intended to be within the scope of claims associated with this disclosure.

Any of the devices described for carrying out the subject diagnostic or interventional procedures may be provided in packaged combination for use in executing such interventions. These supply “kits” may further include instructions for use and be packaged in trays or containers as commonly employed for such purposes.

The invention includes methods that may be performed using the subject devices. The methods may comprise the act of providing such a suitable device. Such provision may be performed by the end user. In other words, the “providing” act merely requires the end user obtain, access, approach, position, set-up, activate, power-up or otherwise act to provide the requisite device in the subject method. Methods recited herein may be carried out in any order of the recited events which is logically possible, as well as in the recited order of events.

Exemplary aspects of the invention, together with details regarding material selection and manufacture have been set forth above. As for other details of the present invention, these may be appreciated in connection with the above-referenced patents and publications as well as generally known or appreciated by those with skill in the art. The same may hold true with respect to method-based aspects of the invention in terms of additional acts as commonly or logically employed.

In addition, though the invention has been described in reference to several examples optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range, is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims associated hereto, the singular forms “a,” “an,” “said,” and “the” include plural referents unless the specifically stated otherwise. In other words, use of the articles allow for “at least one” of the subject item in the description above as well as claims associated with this disclosure. It is further noted that such claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in claims associated with this disclosure shall allow for the inclusion of any additional element—irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of claim language associated with this disclosure.

1. A personal robotic system, comprising:
a. an electromechanical mobile base configured to be controllably movable upon a substantially planar surface in a global coordinate system wherein a Z axis is defined perpendicular to the substantially planar surface;
b. a torso assembly movably coupled to the mobile base such that the torso may be controllably moved in a direction substantially parallel to the Z axis and also controllably rotated about an axis substantially perpendicular to the Z axis;
c. a head assembly movably coupled to the torso assembly;
d. a robotic arm operatively coupled to the torso assembly; and
e. a controller operatively coupled to the mobile base, torso assembly, head assembly, and robotic arm, and configured to controllably manipulate nearby objects while also automatically minimizing destabilizing moments applied to the mobile base through movement of at least one of the mobile base, torso assembly, head assembly, and robotic arm.

2. The system of claim 1, further comprising a sensor operatively coupled to the controller and configured to sense one or more factors regarding an environment in which the mobile base is navigated.

3. The system of claim 2, wherein the sensor comprises a sonar sensor.

4. The system of claim 3, wherein the sonar sensor is coupled to the mobile base.

5. The system of claim 2, wherein the sensor comprises a laser range finder.

6. The system of claim 5, wherein the sonar sensor is coupled to the mobile base.

7. The system of claim 2, wherein the sensor comprises an image capture device.

8. The system of claim 7, wherein the image capture device comprises a 3-D camera.

9. The system of claim 7, wherein the image capture device is coupled to the head assembly.

10. The system of claim 7, wherein the image capture device is coupled to the mobile base.

11. The system of claim 7, wherein the image capture device is coupled to the torso assembly.

12. The system of claim 1, wherein the mobile base comprises a differential drive configuration having two driven wheels.

13. The system of claim 12, wherein each of the driven wheels is operatively coupled to an encoder that is operatively coupled to the controller and configured to provide the controller with input information regarding a driven wheel position.

14. The system of claim 13, wherein the controller is configured to operate the driven wheels to navigate the mobile base based at least in part upon the input information from the driven wheel encoders.

15. The system of claim 2, wherein the controller is configured to operate the mobile base based at least in part upon signals from the sensor.

16. The system of claim 1, wherein the torso assembly is movably coupled to the mobile base such that the torso may be controllably elevated and lowered along an axis substantially parallel to the Z axis.

17. The system of claim 1, wherein the head assembly comprises an image capture device.

18. The system of claim 17, wherein the image capture device comprises a 3-D camera.

19. The system of claim 17, wherein the image capture device is movably coupled to the head assembly such that it may be controllably panned or tilted relative to the head assembly.

20. The system of claim 1, wherein the robotic arm comprises a non-electromechanical gravity compensation subsystem.

21. The system of claim 20, wherein the gravity compensation subsystem comprises an at least partially compressed spring.

22. The system of claim 21, wherein the gravity compensation subsystem is configured such that a load from the least partially compressed spring substantially counterbalances a gravitational load on the robotic arm.

23. The system of claim 1, wherein the controller is configured to minimize destabilizing moments applied to the mobile base based at least in part upon one or more loads applied to the robotic arm.

24. The system of claim 23, wherein the controller is configured to detect one or more loads based upon currents detected in one or more motors operatively coupled to the robotic arm.

25. The system of claim 23, further comprising a sensor configured to produce a signal correlated with a load applied to the robotic arm.

26. The system of claim 25, wherein the sensor comprises a sensing element selected from the group consisting of a strain gauge, a piezoelectric crystal, a ferromagnetic element, a Bragg grating, an accelerometer, and a gyro.

27. The system of claim 1, further comprising a wireless transceiver configured to enable a teleoperating operator to remotely connect with the controller from a remote workstation, and to operate at least the mobile base.

28. A method for manipulating physical objects in a human environment, comprising:
a. providing a personal robotic system comprising an electromechanical mobile base configured to be controllably movable upon a substantially planar surface in a global coordinate system wherein a Z axis is defined perpendicular to the substantially planar surface; a torso assembly movably coupled to the mobile base such that the torso may be controllably moved in a direction substantially parallel to the Z axis and also controllably rotated about an axis substantially perpendicular to the Z axis; a head assembly movably coupled to the torso assembly; and a robotic arm operatively coupled to the torso assembly; and
b. operating the personal robotic system such that the robotic arm manipulates one or more nearby objects while also automatically minimizing destabilizing moments applied to the mobile base through movement of at least one of the mobile base, torso assembly, head assembly, and robotic arm.

29. The method of claim 28, further comprising providing a sensor operatively coupled to the controller and configured to sense one or more factors regarding an environment in which the mobile base is navigated.

30. The method of claim 29, wherein the sensor comprises a sonar sensor.

31. The method of claim 30, wherein the sonar sensor is coupled to the mobile base.

32. The method of claim 29, wherein the sensor comprises a laser range finder.

33. The method of claim 32, wherein the sonar sensor is coupled to the mobile base.

34. The method of claim 29, wherein the sensor comprises an image capture device.

35. The method of claim 34, wherein the image capture device comprises a 3-D camera.

36. The method of claim 34, wherein the image capture device is coupled to the head assembly.

37. The method of claim 34, wherein the image capture device is coupled to the mobile base.

38. The method of claim 34, wherein the image capture device is coupled to the torso assembly.

39. The method of claim 28, wherein the mobile base comprises a differential drive configuration having two driven wheels.

40. The method of claim 39, wherein each of the driven wheels is operatively coupled to an encoder that is operatively coupled to the controller and configured to provide the controller with input information regarding a driven wheel position.

41. The method of claim 40, wherein the controller is configured to operate the driven wheels to navigate the mobile base based at least in part upon the input information from the driven wheel encoders.

42. The method of claim 29, wherein the controller is configured to operate the mobile base based at least in part upon signals from the sensor.

43. The method of claim 28, wherein the torso assembly is movably coupled to the mobile base such that the torso may be controllably elevated and lowered along an axis substantially parallel to the Z axis.

44. The method of claim 28, wherein the head assembly comprises an image capture device.

45. The method of claim 44, wherein the image capture device comprises a 3-D camera.

46. The method of claim 44, wherein the image capture device is movably coupled to the head assembly such that it may be controllably panned or tilted relative to the head assembly.

47. The method of claim 28, wherein the robotic arm comprises a non-electromechanical gravity compensation subsystem.

48. The method of claim 47, wherein the gravity compensation subsystem comprises an at least partially compressed spring.

49. The method of claim 48, wherein the gravity compensation subsystem is configured such that a load from the least partially compressed spring substantially counterbalances a gravitational load on the robotic arm.

50. The method of claim 28, wherein the controller is configured to minimize destabilizing moments applied to the mobile base based at least in part upon one or more loads applied to the robotic arm.

51. The method of claim 50, wherein the controller is configured to detect one or more loads based upon currents detected in one or more motors operatively coupled to the robotic arm.

52. The method of claim 50, further comprising a sensor configured to produce a signal correlated with a load applied to the robotic arm.

53. The method of claim 52, wherein the sensor comprises a sensing element selected from the group consisting of a strain gauge, a piezoelectric crystal, a ferromagnetic element, a Bragg grating, an accelerometer, and a gyro.

54. The method of claim 28, further comprising providing a wireless transceiver configured to enable a teleoperating operator to remotely connect with the controller from a remote workstation, and to operate at least the mobile base.
